(19) United States
(12) Patent Application Publication
(10) Pub. No.: US 2009/0259549 A1
(43) Pub. Date: Oct. 15, 2009

(54) METHODS AND SYSTEMS FOR OPTIMIZING FLOW

(75) Inventors: Henri M. A. Winand, Leicestershire (GB); Paul J. Harris, Derbyshire (GB)

Correspondence Address: EGBERT LAW OFFICES, 412 MAIN STREET, 7TH FLOOR, HOUSTON, TX, 77002, US

(73) Assignee: MANTIC POINT SOLUTIONS Limited, Leeds (GB)

(21) Appl. No.: 12/306,840

(22) PCT Filed: Jun. 29, 2006
(86) PCT No.: PCT/IB06/01864

§ 371 Date: Feb. 25, 2009

(30) Foreign Application Priority Data
Jun. 30, 2005 (GB) 0513422.6

(51) Int. Cl. G06Q 30/00; G01S 5/00

(52) U.S. Cl. 705/14.35; 342/357.07

(57) ABSTRACT

The present invention is a method of optimizing the flow of entities. The method includes the steps of:
i) tracking the position of a plurality of the entities;
ii) repeatedly:
   comparing each of the positions with a target profile; and
   calculating or adjusting a reward potential for each entity on the basis of the comparison; and
iii) rewarding a selected number of entities on the basis of the reward potential associated with each of the entities at a predetermined time.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to methods and systems for optimizing the flow of entities. It is particularly, but not exclusively, related to methods and systems for optimizing the movement of passengers and/or luggage, and especially for reducing passenger related delays in a transport environment.

2. Description of Related Art Including Information Disclosed Under CFR 1.97 and 37 CFR 1.98

In a number of situations, it is desired to ensure timely arrival of entities such as people, luggage, vehicles, etc. at a destination.

GB2498617A discloses methods and systems which track the location of entities and take action to assist their passage to a destination by generating alerts when the entity has not reached a specified zone by a particular time.

However, whilst such methods and systems can assist e.g. operators of aircraft in achieving timely arrival of passengers at departure gates, they work on a “negative” basis, in that pressure is placed on the passenger to complete actions in a specified time scale to avoid alerts/reminders. Such methods and systems do not provide any “positive” incentive to the passenger.

Methods and systems for tracking the movement of people are widely known, and include the personal locator systems offered by Wherify Wireless Inc. (www.wherifywireless.com), which use GPS receivers and two-way pagers or mobile telephones to allow parents to track or locate children, and also provides a “breadcrumbing” feature to allow the setting of “locates” to ensure that a person arrives at an event.

Use of location information provided by, for example, mobile telephones (e.g. a Location Based Service (LBS) track, which is the service provider's knowledge of the location of a handset) is also increasingly common. Such information may also be used to contact or meet other users using “mobile social (networking) software”—“MoSoSo”, for example as provided by Trilibis Inc. under the “peepsnation” trade mark (www.peepsnation.com), or by Imahima Inc. under the “imaHima” trade mark (http://www.imahima.com/).

### BRIEF SUMMARY OF THE INVENTION

The present invention seeks to provide methods and systems, which provide an easier and more entertaining travel experience. The invention also seeks to optimize (preferably increase) the usage of facilities and improve the timekeeping by the provision of customer pull and push functions.

An object of the present invention is to make convergence easier and rewarding between people and events, e.g. by making connections between people simpler and more entertaining.

Accordingly, at its broadest, the present invention provides systems and methods, which provide a material reward for entities, which comply with criteria defined by the system/method, particularly with regard to location. In one aspect of the invention, the reward and criteria are arranged to encourage an entity to reach a particular location or event (such as a the departure of an aircraft or train) on time.

A first aspect of the present invention provides a method of optimising the flow of entities, including the steps of:
i) tracking the position of a plurality of said entities;
ii) repeatedly:
   comparing each of said positions with a target profile; and
   calculating or adjusting a reward potential for each entity on the basis of said comparison; and

iii) rewarding a selected number of entities on the basis of the reward potential associated with each of said entities at a predetermined time.

The selected entities are preferably a subset of the plurality of entities being tracked, and more preferably are a small proportion of those entities.

Preferably the flow of entities is towards a destination, and the step of rewarding is carried out at a required arrival time at that destination.

In most embodiments, the entities that are rewarded are selected by virtue of having the highest reward potentials at the predetermined time.

However, the method of the present invention can also be used in an “inverse” manner to penalize entities whose location does not fall within the target profile, e.g. by failure to arrive at a destination on time. Although the description will focus primarily on “rewards”, corresponding implementations of an inverse method or system also fall within the present invention.

Preferably in at least one repetition in the above method, said step of calculating or adjusting increases the reward potential if the position of the entity falls within the target profile. In such an implementation, the entity can be rewarded for being in a desirable location.

Alternatively or additionally, in at least one repetition in the above method, said step of calculating or adjusting decreases the reward potential if the position of the entity falls within a particular spatial region. Therefore an entity can be penalized for being in a non-desirable location.

Accordingly, the method of this aspect may reward entities which best manage to keep their location within their target profile over the predetermined time period. Optionally, the method may reward those entities, which do not stray into areas outside their target profile by penalizing other entities who do move into such areas, and making them less likely to be rewarded.

A target profile is preferably a defined region of space that the entity should be in at a particular time. The target profiles may change with time, and in particular may be dynamically updated to take account of local circumstances, which may affect the movement of the entities.

The target profiles may be the same for all of the entities being tracked, or for a group of entities, or may be tailored individually to each entity.

The present invention is particularly applicable in a transport environment, and specific implementations in an airport environment are envisaged. Such implementations will be used in an exemplary manner, and it will be appreciated that certain functions, features and advantages of such implementations are of general applicability.

The entities may include a plurality of people, some of which may be passengers travelling to a departure area. The entities may also include a plurality of inanimate objects such as luggage, vehicles etc.

Where the entities include both people and inanimate objects, at least one of said inanimate objects may be associated with a person.

Preferably the method improves issues such as queue management at choke points (e.g. in an airport or other transportation hub) and improves movement between zones. In certain embodiments, the invention may enable effective management of delayed passengers along their routes to the aircraft; provide passengers with timely and relevant information such as time left in a zone; enhance the quality of airlines' decisions in relation to ‘offloading’ of delayed passengers and their luggage within a timeframe designed not to excessively jeopardize the timely departure of aircraft whilst assisting high yield passengers throughout their journey to the departure gate.

By employing a method according to the present aspect, or a system according to the following second aspect, an airline may be able to reduce passenger churn through a better perception of the service provided to them. The aspects of the invention may also allow airlines or airport operators to shorten the average passenger boarding time, increase the on-time departure of aircrafts and/or increase the number of plane rotations per day and per departure gate.

The reward potential for an entity may also be adjusted when the entity performs a particular action.

For example, the action may be a purchase in a retail area, and the increase in the reward potential may be linked to the monetary amount spent in the retail area. By providing such an increase in the reward potential, entities can be encouraged to make purchases in that retail area.

By rewarding entities for maximizing time and cash spent in a retail area, e.g. in an airport, the entities are encouraged to perform such actions, thereby increasing profit for the retailers and for the location/facility operator.

As another example, the action may be the placing of a bet.

Therefore an entity may be able to bet (either backing or laying odds) as to whether or not they (or any other entity or group of entities) will get to a destination or event on time, according to a particular Breadcrumbing Track, within a particular “timeliness” or reward profile, etc.

Any adjustment made to the reward potential may depend on the time at which the action is performed. In such a way, purchases or other actions by the entity, which are likely to delay their progress to a destination can be rewarded less than purchases or other actions which are likely to have minimal effect on the progress of the entity.

A further development of the present aspect provides the further step of providing a meeting arrangement service to the entities, whereby participation in said meeting arrangement service increases the reward potential of the participating entities.

In providing a meeting arrangement service the method may use the position and/or target profile of participating entities to arrange a meeting between a plurality of entities. For example, the meeting arrangement service could only arrange meetings between entities, which are within a certain physical distance of each other, or are likely to be within a certain physical distance at a time in the future according to their target profiles. Alternatively or additionally, the meeting arrangement service may only arrange meetings between entities, which are sufficiently within their target profile from a timeliness perspective to have time for the meeting and remain within their profile(s).

The step of arranging a meeting may use stored personal information relating to the participating entities to match together entities for a meeting. For example, entities with similar or complementary interests, hobbies or jobs may be matched. For example, this could include but is not limited to entities, which are interested in meeting for leisure pursuits (e.g. golf, football, second-homers) or entities with a business interest. In one embodiment of the invention, this information may be collected by allowing entities to register their interests through an affinity website (e.g. a business networking web-sites such as Linked-In, or ecademy). An entity may register their interests on a permanent basis, or may specify when using the meeting arrangement service criteria for the match.

Preferably the identity of a participating entity is confirmed by using information provided by the entity.

In particular, the entity may arrange to participate in the meeting arrangement service by using a mobile device, such as a mobile telephone, and the information provided by the entity regarding their identity may be automatically obtained from that mobile device without further input from the entity.

The method may further include the steps of storing and analysing information relating to said tracked positions.

Information on location, time and passenger transaction types obtained from interactions with network connected devices or other system connected devices such as kiosks or in airplane terminals or voice may allow the provider of the method (e.g. retailers and airport operators) to understand better the flow and behaviour of their customers.

Such analysis may be done substantially in real time, or alternatively performed on historical data. The results of the analysis may be used to update existing or future target profiles.

Preferably the step of rewarding allocates rewards to the selected entities as a share of an accumulated reward pool.

Such a reward pool may accumulate value through the actions of the entities, which are being tracked. For example when an entity registers for tracking, e.g. by sending a message from a mobile device, and a charge for that entry (e.g. a charge for the message) is allocated to the reward pool.

Similarly, where entities place bets, a service charge for each bet may be allocated to the reward pool.

Likewise, where entities participate in the meeting arrangement service, a service charge may be allocated to the reward pool.

Preferably entities are able to obtain, on request, an indication of the current likelihood of their selection for being rewarded.

Accordingly the method may include the further step of providing, on request from an entity, an indication of the current likelihood of that entity being selected for a reward.

Such a request from an entity may be charged for, and that charge may be allocated to the reward pool.

A second aspect of the present invention provides a system for optimising the flow of entities, including:

i) a tracking unit for tracking the position of a plurality of said entities;

ii) storage means for storing at least one target profile;

iii) a reward engine adapted to repeatedly:
compare each of said positions against one of said stored target profiles and
calculate or adjust a reward potential for each entity on the basis of said comparison,
and further adapted to select a predetermined number of said entities on the basis of the reward function associated with each of said entities at a predetermined time, and to allocate a reward to said selected entities; and

iv) a reward unit for distributing said rewards to the selected entities.

The system of the present aspect is preferably designed and adapted to implement the method of the first aspect above, including any combination or all of the optional and preferred features of that aspect.

Preferably the flow of entities is towards a destination, and the reward unit is located at that destination. For example, one or more kiosks could be located at the departure gate area in an airport. When an entity interacts with one of said kiosks, they can see the reward points they have earned and if they have earned a sufficient number of reward points they can elect to redeem their reward points. In one instance, this could involve selecting from a range of prizes (e.g. free mobile-phone ringtone download, a discount on airport parking, etc.) using a touch-screen on the kiosk to select the preferred reward. Each reward may have a cost, denominated in reward points, so the more points an entity has earned, the more valuable reward they are entitled to. The kiosk could optionally print a voucher to enable the entity to redeem their reward at the appropriate outlet. Once the reward has been redeemed the entities point score may be reduced by the cost of the selected prize in reward points. Preferably the reward engine is adapted to select those entities with the highest reward potentials on arrival at the predetermined time.

The reward engine may also adapted to adjust the reward potential for an entity when the entity performs a particular action.

In particular embodiments, the system further includes a retailer unit, and the action of the entity is a purchase in a retail area, the increase in the reward potential being linked to the amount spent in the retail area.

The system may further include a betting engine, which processes bets laying or backing a particular outcome and the action is the placing of a bet.

Preferably the betting engine processes bets regarding the movement of entities being tracked by the system. The betting engine may of course process other bets as well or instead of such bets.

The system may further include a connection engine which arranges meetings between entities on request, and communicates details of the meetings to the participating entities, and further wherein the reward engine is adapted to increase the reward potential of the participating entities.

The connection engine may be adapted to use the tracked position and/or target profile of the participating entities to arrange a meeting between said entities.

The system may further include storage means for storing personal information relating to the participating entities, wherein said connection engine uses said stored personal information to match entities to arrange a meeting.

Preferably the connection engine is adapted to confirm the identity of a participating entity by using information provided by the entity prior to the arrangement of a meeting.

The system may further include a receiving unit which is adapted to receive a message from a mobile device carried by an entity, the message indicating the entity's desire to use the connection engine, said receiving unit and/or said connection engine being adapted to confirm the identity of the entity using data from the mobile device.

The entities may include a plurality of people, and the tracking unit may track mobile electronic devices carried by said people. This tracking may use a GPS (or other satellite location)-based system. If the mobile electronic devices are mobile telephones, the tracking unit may track those telephones using a location based service track, or any conventional triangulation technique.

Accordingly the tracking of the entities may be continuous and automatic. However, in alternative embodiments, some entities may be tracked by alternative means, such as regular messaging or detection of the entity in a particular zone or area. Entities may select whether or not they are tracked continuously. For example, mobile phone location based services can be used to continuously track an entity to a particular mobile phone cell, license plate recognition technology can be used to identify when an entity has reached a car-park (where the entity shares their license plate with the system during the registration process), Wi-Fi enabled devices can be tracked continuously within an airport that is equipped with a Wi-Fi network and a sufficiently dense network of access points as to enable triangulation of an entity's position, a radio frequency identification tag (RFID) can be applied to a boarding pass and readers/antenna placed at choke-points throughout the airport to track the entity to a specific zone, barcode technology can also be scanned as an entity moves from zone to zone (e.g. as they move from landside to airside through outbound control).

The system may further include storage means for storing and reproducing on demand information relating to said tracked positions. Such information can be used for analysis of the patterns of use of the system, and the paths taken by the entities whilst being tracked by the system and could be used to optimise future operations, or to tailor future rewards.

The reward engine may be further adapted to receive a request from an entity, and to provide, in response to said request an indication of the current likelihood of that entity being selected to be rewarded.

Several methods of interaction between entities and the system may be provided for, for example using SMS, voice (e.g. an automated voice recognition system or a call centre), instant chat or MMS services, using dedicated kiosks which provide entities with access to the system and/or a web server which allows entities to access the system. Thus the entities may interact with the reward engine, betting engine and/or connection engine as applicable/desired.

Preferably the system further includes a billing engine adapted to charge entities for specific interactions with the system, and the reward allocated by the reward engine is derived from a pool of the charges made by said billing engine.

The system may further include at least one intelligent device connected to the system, the intelligent device(s) providing information to the reward engine and/or tracking unit, and being capable of adjusting target profiles, reward functions and/or reward potentials for entities.

Optionally, a plurality of intelligent devices may be provided which are interconnected and share information, and optionally work in concert.

Accordingly, devices (such as machines, kiosks, facilities) may adjust target profiles, or rewards on the basis of their utilisation, thereby increasing their utilization to the benefit of their operator.

The system may further include an intelligent agent associated with at least one entity, said agent interacting with the system on behalf of that entity.

Such agents can remove the need for entities to remember to interact with the system themselves, and are preferably capable of being tailored to suit the preferences and habits of the entity with which they are associated. This can make interaction with the system easier for entities.

The system can either be distributed into assets or organised via a central system using either a software agent technology or more traditional database based approaches to keep track of the different entities in the system over time and allocate accumulated rewards to the relevant entities.

### BRIEF DESCRIPTION OF THE SEVERAL VIEWS OF THE DRAWINGS

Embodiments of the invention will now be described with reference to the accompanying drawings.

FIG. 1 shows a graph illustration of an example reward profile for travel in 1 dimension.

FIG. 2 shows a graph illustration of a further example reward profile for travel in 1 dimension.

FIG. 3 shows a graph illustration of a further example reward profile for travel in 1 dimension.

FIG. 4 shows a graph illustration of a further example reward profile for travel in 1 dimension, including target zones.

FIG. 5 shows a graph illustration of a further example reward profile for travel in 1 dimension, including detection zones.

FIG. 6 shows a graph illustration of an example track of a travelling entity in three dimensions.

FIG. 7 shows a graph illustration of an overhead view of the example tracks of two different entities travelling to the same destination.

FIG. 8 shows a schematic view of an example hardware and network devices forming part of the system of an embodiment of the present invention.

FIG. 9 shows a schematic view of an example system interactions for the example of a passenger travelling to an airport.

FIG. 10 shows a schematic view of a further example system interactions for the example of a passenger travelling to an airport.

FIG. 11 shows a schematic view of examples of passive consumer interaction in a facility such as an airport.

FIG. 12 shows a schematic view of examples of retail operators' business interactions with the system of an embodiment of the invention.

FIG. 13 shows a schematic view of examples of user interfaces which allow an entity to interact with the system of an embodiment of the invention.

FIG. 14 shows a schematic view of examples of the ways in which the system of an embodiment of the present invention can be used for data management.

FIG. 15 shows a schematic view of the security features of the system of an embodiment of the present invention.

FIG. 16 shows a schematic view of examples of authentication processes used in an embodiment of the present invention.

FIG. 17 shows a schematic view of examples of interactions between a system of an embodiment of the present invention and external entities.

FIG. 18 shows a schematic view of a possible arrangement of a system according to an embodiment of the present invention.

FIG. 19 shows a schematic view of a simplified example of a passenger moving through zones to a destination.

FIG. 20 shows a schematic view of a system according to an embodiment of the present invention.

### DETAILED DESCRIPTION OF THE INVENTION

The embodiments below describe operation of the present invention in a transport environment. For ease of reference, the following terms will be used in these embodiments:

“Vehicle” includes but is not limited to a means of transportation such as a plane, lorry, bus, train, car, barge or ship. This includes civil and military vehicles as well as all other means of transportation such as walking, cycling, etc.

A “passenger”, is defined to be, but not limited to, a person who needs to reach a given location at a given time. A passenger who has not started their journey yet, or other, non-travelling persons are referred to as “people”.

“Luggage” is a single item or collection of items or cargo which may be associated in some way with a particular passenger or group of passengers, and which needs to reach a given location at a given time to be placed on and/or removed from on a vehicle or to go through a particular process to reach their destination. This includes civil and military luggage.

Vehicles, passengers and luggage are all examples of entities.

A “vehicle operator” is the operator of one or more vehicles. This can be a passenger, if the passenger travels using their own vehicle of other means of transportation.

A “facilities operator” is the operator of the whole or part of the facilities encountered on a journey that a passenger undertakes and includes departure or arrival facilities.

A “departure area” is an area within which a vehicle will leave from/arrive at a particular time and where passenger(s) and/or luggage have to arrive to ensure timely departure/arrival of the vehicle.

An “event” includes, but is not limited to, an outcome, something that happens (occurrence), a social occasion or activity, a contest in a program of sport/fashion/art/etc., or any combination of events. Generally, events take place over a variable length of time and at one or more locations and involve the confluence of one or more entities.

A “connection” is the outcome of the intersection a plurality of People/Passenger(s)/Asset(s)/etc. at a Location, Meeting, Event or Event Area.

A “Meeting” or “Event Area” is an area where an entity is supposed to arrive at or leave from at a particular time. In particular, this includes departure areas.

A “zone” is a fixed or variable physical or logical area through which entities may travel or in which entities may stay for a period of time.

An “animate object” is an entity which is capable of making decisions, e.g. passenger(s)/people, vehicle operator(s), facilities operator(s), provider(s).

An “inanimate object” is an entity which is not capable of making decisions, e.g. vehicle(s), luggage, asset(s), departure area(s), event(s), connection(s), meeting(s), zone(s), software agent(s).

A “software agent” is an intelligent software object that can be programmed to operate proactively to achieve predefined goals. The agent has ability to gather information, reasoning to evaluate it and the authority and autonomy to act on that information without further input.

A “reward function” (“RF”) is a function which can be positive, negative, null (to reset the Reward to zero), one (no change) or any other continuous (e.g. exponential) or discontinuous (e.g. step function) function, and is associated with a “reward travel profile” of an entity or group of entities according to the movement or actions of that entity or group.

A “reward pool” is the pool containing the accumulated or total reward available to be distributed to the entities interfacing with the system.

A “conversion engine” provides process, methods, rules and logic, to keep rewards/penalties/coordinates, etc relevant to the reference framework of the entity in question—see description in subsequent sections.

“Billing Engine(s)” process, methods, rules and logic—see description in subsequent sections.

“Gaming Engine(s)” process, methods, rules and logic—see description in subsequent sections.

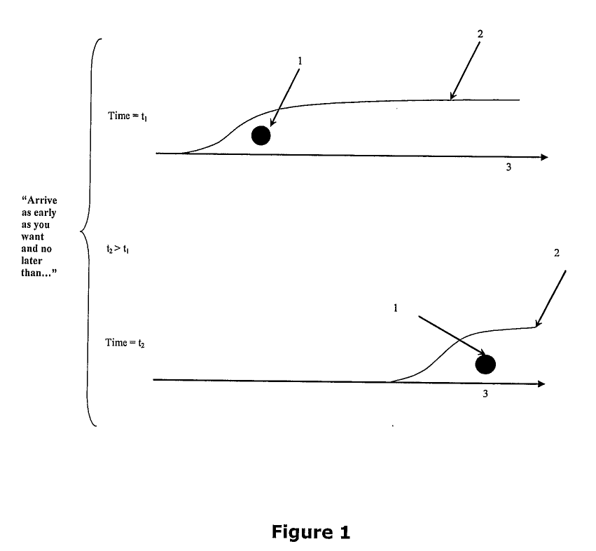

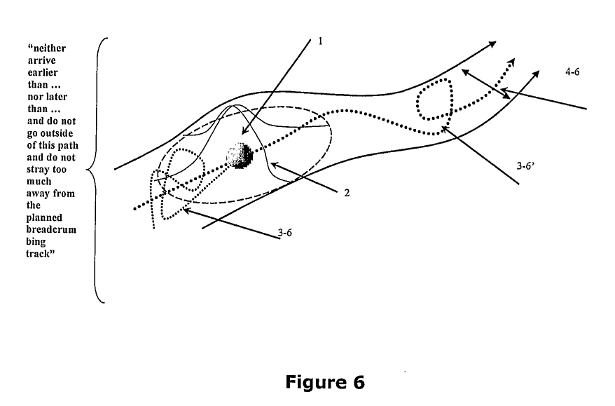

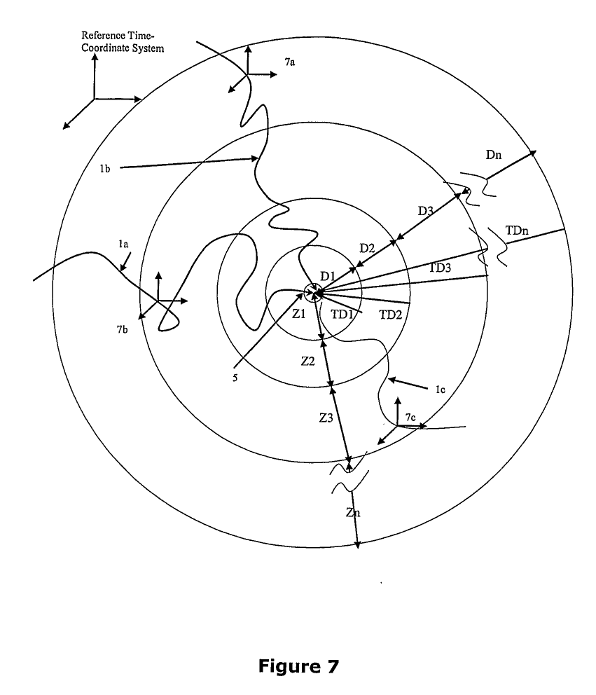

A “Travel Path width” is a one, two, three or four dimensional geometry (any combination of X, Y, Z and/or T) within which the travelling Entity(ies) are expected to lie at any time or not lie at any time (in a particular Time Coordinate System). The travel path widths can vary with time T, be discontinuous or remain fixed in shape throughout. For example, the travel path width may have a decay function to only show the last x minutes or remain throughout. FIGS. 1-5 show two-dimensional tracks (X+T), FIG. 7 shows a three-dimensional track (X, Y+T) and FIG. 6 shows a four-dimensional track (X, Y, Z+T).

The “compliance factor” (“CF”) or “reward probability” (“RP”) is a factor between 0 and 1 which reflects the probability of an entity winning its reward potential.

The “ahead factor” (“AF”) of a particular entity is a number which represents the number of other entities that are considered by the system be ahead of that entity in terms of the likelihood of winning their reward potential. If this number is 0, then RP for that entity is likely to be 1 or close to 1 as the person is likely to be the winner at that moment in time.

A “target zone” is a physical or logical zone (which can vary over time in size(s) and position(s)) in which the Reward Function(s) of entities in that zone can either increase or decrease by the application of a particular function associated with the target zone.

A “Reward Travel Profile” is a one, two, three or four dimensional geometry (selected from any combination of X, Y, Z and T, i.e. can vary with time T, be discontinuous or remain fixed in shape throughout) and can be generated for any of the above defined object for any duration in time. In essence, if an object falls outside (or within) an associated Reward Travel Profile, one or more Reward Function(s) are applied to the object which may adjust the Reward Potential of the Object(s).

A “detection zone” is a zone within which an entity may be detected (discretely or continuously). Presence of an entity in a detection zone will affect that entity's Reward Potential through the application of relevant Reward Function.

A “breadcrumbing track” is a one, two, three or four dimensional geometry (selected from any combination of X, Y, Z and T) and is the track left behind an entity for any duration of time as they move. The breadcrumbing track can vary with time T, be discontinuous or remain fixed in shape throughout (e.g. it may have a decay function to only show the last x minutes or remain forever or not be present at all).

The embodiments of the invention set out the methods, processes and systems underpinning reward and connection engines which provide entities (e.g. People, Assets, etc.) with incentives for reaching a destination, possibly via intermediate locations, in good time. These methods, processes and systems use a combination of time/location, and breadcrumbing capabilities, with the ability for devices, people and operators to set odds (e.g. using the gaming engine) on travel profiles and incentive programmes. The embodiments also integrate one-click-type features for mobile devices to identify an entity, a conversion reward and billing engine, and provide for the integration of software agent technology with the above engines.

Embodiments of the present invention allow the behaviour of entities to be influenced by linking them and their identity through the use of unique ID with location devices (e.g. mobile phone LBS/tracks, RFID, barcode, hotspots [WiFi/WiMax/Zigbee, etc.], GPS, video recognition/footfall analysis devices, turnstiles, etc.) with time devices, and a system which stores information about the entity and processes the interaction of the entity with the various engines discussed below.

The system may store a set of logic instructions which are associated with a particular entity and are actioned by the system according to the entity's physical location as determined by sensory networks (e.g. RFID, barcode (e.g. printed on a ticket or tag, or displayed electronically on a mobile phone or hand-held device, GPS, etc.) linked to the system. These logic instructions may be programmed and/or accessed by the passenger himself or other people with an interest in the entity process (such as airport or airlines operators) via devices such as www browsers, system specific interfaces and mobile phones. As a result, particular zones may be defined as good/bad zones for that entity or for a group of entities, reward profiles can be set up, and the type of rewards can be adjusted according to the entity in question.

The system may also keep track in one or more databases of the entity's preferences such as whom they want to meet, what they like to receive as rewards, when they tend to travel, etc.

In a general example, the system can uniquely identify an entity. For example, for a person using a mobile phone, this can be done using the mobile's Device Digital ID or simply using the phone number of the mobile phone provided by the entity. The entity can interface with the system via multiple channels/interfaces. The sensory network (such as a “Location Based Service” track in the mobile telephone example above, which returns the position of the cell in which the mobile is) reports the location of the entity to the system.

The system retrieves the entity's details (from, for example, a database or from the intelligent agent that is the virtual “avatar” equivalent to the physical entity—see discussion below) and compares the entity's location and time in the process with one or more reward profiles. The system can then determine if the entity is to be rewarded or not according to the reward profile(s). The system can also determine the nature of the reward and add the reward to the reward pool according to the reward potential of the entity.

Each of the operations above will typically involve logical operations on the existing data and updating of the relevant database(s).

The entity can check the reward allocated to him via a communications channel such as SMS, a website, an updated “Flight Information Display” {FID} and can be allocated the rewards by a reward unit, for example by an ATM prompted by the system that when the entity identifies itself to the unit, for example by keying in its details or by providing an RFID or barcode matching a given number. The ATM can then allocate the entity a cash reward according to the entity's reward allocation.

For example, in the situation of a passenger travelling to/through an airport, an embodiment of the invention provides a system which uses appropriate databases and sensory networks which detect or monitor the passage of the unique identifier associated with that passenger to act on the combination of the passenger's location, a time reference (which may be a real time, a time zone, a time relative to a specific event, etc.) and the passenger's defined preferences, and compares one or more of these indicators with a reward profile in order to allocate reward to the passenger. The reward profile may be defined, for example, by the facility operator (who provides incentives/penalties to encourage a passenger to act in a manner which increases the airport's efficiency or revenue) or by a passenger themselves betting on their path/timeline.

In a general embodiment of the invention, a person who wishes to travel may decide to join the reward/connection system offered by a facility operator, vehicle operator or independent provider (normally in association with a facility operator, vehicle operator or both). In so doing, the person can be rewarded by the operator of the transportation system for compliance with set targets which are advantageous to the provider or their associate(s), such as timely arrival, and also potentially for interaction with other stakeholders along the person's trip, such as retailers present on the way to the departure area.

In a development of the above general embodiment, the system permits the person to effectively take a bet on their own trip such that if they fully comply with the “rules of the trip” (including, for example, being on time for the departure of an aircraft; spending money in retail operators; not crowding the security queue area during peak hours; using the meeting/networking facilities of the system (which in turn may further increase retail spend in the airport); or allowing themselves to be tracked for the duration of the trip so that airport and airline operators can make decisions on how to handle the flow of passengers through their operations) over the duration of the trip, or purchase additional reward equity from the engine to increase further their odds of winning a share of the total reward pool that operators, passengers have contributed to the total reward pool. The “rules of the trip” are fully flexible, coordinate (including zone based), and time based set of coordinates, for example using breadcrumbing (a trail left by a moving entity) or travel path width (a set of coordinates within which entities are required to move or to be excluded from).

Although the detailed embodiment of the invention will be described in relation to a passenger environment at an airport (or other transport hub), the invention is of more general applicability to e.g. amusement parks; (intelligent) device centric engines (see description below of intelligent devices); retailers; event organisers, such as sports and music; and even mundane home events.

In addition to standard consumer offerings detailed elsewhere such as the provision of additional dynamic travel information, consumer direct marketing and offers, the system of a general embodiment of the invention incorporates a Reward Engine and, optionally, a Connection Engine. These Engines are described in more detail below.

The Reward Engine delivers rewards to selected participating entities on the basis of factors such as yield, time and location. The rewards themselves may take any form, such as information meaningful to the entity, credit for use with particular retailers or operators, or cash. The Reward Engine operates to make such rewards yield, time and location managed.

Accordingly, passengers receive meaningful incentives if they reach and stay within coarse time and location parameters (e.g. zones defined physically or logically by the Reward Profile, which may of any size or shape) outside and inside the airport all the way to the departure gate. In addition, passengers are further rewarded if they do particular activities in a particular order, which may be further reflected in the Reward Profile by using Target Zones, thereby providing a location (zone), time and desired behaviour for a particular time and space.

Passengers elect to participate through the use of their mobile phone or other mobile device(s), and their system accounts are accessible via standard web browsers, dedicated kiosks.

Passengers can also elect to participate through a standard web-browser. The web-browser may be accessing a dedicated website that belongs to the system, or could be integrate with the airline booking web-site or the travel operator's web-site, or the airport operator's web-site.

Passengers can boost their chance of winning rewards by increasing their share in the overall reward equity pool by, for example:

(i) staying in zones at times determined by the Reward Engine likely to ensure that they will be on time throughout their journey (Target Zones);
(ii) arriving at the departure gate within a well defined time window (a specific example of a Target Zone);
(iii) purchasing from participating retail outlets;
(iv) directly buying equity into the reward pool using their mobile phone (e.g. via SMS/MMS micro payments), kiosks, internet connected devices, telephone credit card accounts or any other network connected account;
(v) by electing to be tracked by the system for their entire journey towards the departure gate including progress tracking of their trip towards the airport using, for example, existing mobile phone cell technology (e.g. either interrogating the system sending it unique location codes, such as Mamjam-type code issued via SMS/MMS or other network connected device, as many times as possible to give the system more location/time coordinates to work from or allowing the system to track the person through their mobile, for example using LBS tracks, or some other means of mobile phone triangulation or a built-in GPS-type system);
(vi) using the system's Connection Engine described below;
(vii) interrogating the system more often, for example to request an update on the departure time of a vehicle (e.g. plane), or to use other services, and accepting a surcharge billed to their account in doing so;
(viii) placing cash/other currency bets on their travel progress or on the location of any entity at a given time (e.g. aircraft departure time, other passenger arrival time, number of passengers late for a designated flight, time of arrival of luggage, friends not arriving, will I meet a friend or business connection, etc.).

At its most simple, passengers merely have to be “surfing a wave of timeliness”, i.e. moving within their personal Reward Profile, in order to be eligible for a reward. Each entity that is travelling has at least one such Profile, and in addition to the wave of timeliness, the passenger may also travel a particular Breadcrumbing Track or set of Tracks that the system (or particularly, the system operator(s)) deems to be most effective for their own purposes, and thus have a chance of receiving a reward such as vouchers. In a more aggressive embodiment, cash dispensers could be integrated as kiosks connected to the system's reward engine and placed in the departure gate area. As passengers drop their Active Boarding Card or merely pass through that area, the system determines if they have complied with the best time/zone/behaviour profile, what portion of the overall reward pool is available to them, how many such compliant passengers have actually won and may make an instant payment through the cash dispenser kiosk connected the system.

Other prizes could include winning a car or alternative significant, memorable and/or extraordinary offers. The prize winners may be announced just before boarding, for example through a message to a mobile phone and/or the local kiosk connected to the system placed in the departure zone, or over a broadcast system. Such a late announcement may be advantageous in that the passenger will then go into a confined space (e.g. an aircraft or event) in which the buzz and excitement of such an instant win will have a chance of propagating during the trip/event which may then increase the service take-up through word of mouth or viral marketing.

To encourage passengers check their system account over the web, a preferred method is to display on a kiosk at the departure gate connected to the system or through the sending of a message/alert to their mobile device or over a speaker system the fact that the passenger has won some cash (or other reward), with the cash/reward in question being placed under management in their system account (which may be connected to existing internet based infrastructures and understood and trusted multicurrency services such as PayPal™) and which can be redeemed through access to their system accounts. The system could also share in a percentage of the interest that such deposits will attract if the passenger does not redeem their winnings balance on that day.

As consumers hear about and become more conversant with the system, they can make good use of added value functions to increase their rewards. The Reward Engine may be configured to allocate a wide range of prizes such as money off vouchers, ring tones, connections with famous people who are also at the Event location or travelling in the same vehicle (which may be arranged through the Connection Engine discussed below) if both the passenger and star have opted in.

The Reward Engine can determine from the consumer profile and age, whether a passenger is entitled to, or wishes to, receive particular rewards. The system may accordingly store opt-in, filter and profile preferences, as known in existing “one-click” equivalent systems, which using the unique identity address of a mobile device such as the phone number of a mobile phone, the SIM card number or the IP/network address of a device on the Internet and the fact that the passenger is already known to or registered with the system.

Passengers can elect to “bank” their prize, or to trade their reward for alternative rewards, or for larger shares of future equity pools ran by the Reward Engine, or to boost their overall reward level using the online system trading platform on which people who have been allocated rewards can trade them online.

The Reward Engine is configurable and can run in various ways including time, group (proving/analysing group behaviour dynamics and reward strategies) and location limited modes.

A second part of the system is designed to bring people together, and will be referred to as the Connection Engine. The Connection Engine may be implemented separately from the Reward Engine with networked or direct connections between the two parts of the system, or as separate software running on the same computer, or as part of a single software package.

The Connection Engine operates to make it easier for entities, in particular people, to take advantage of the natural convergence points such as airports and to arrange meetings in such locations (e.g. airports and, later, planes) with people who match a search criteria profile. The search criteria can be defined and maintained using their system account over the internet or via kiosks or other network connected devices linked with the system.

Once in or close to an area which the Connection Engine is serving (e.g. an airport), users can activate the connection facility by sending a message to the Connection Engine (e.g. a premium SMS/MMS, a voice command, or an electronic message through any network connected device such as a kiosk, PDA or other internet account).

The Connection Engine provides a service for people who want to meet others whilst on their way to their holiday or business trip, either for social or business purposes. Such uses include dating and business networking.

It should be appreciated that the Connection Engine can be configured to enable entities both to meet other entities that are currently unknown to them (e.g. entities wishing to meet other like-minded business or leisure entities) and/or to meet with entities that they already know.

For example, one application of the Connection Engine is to help groups of entities that are travelling together, but arriving at the airport independently, to keep in-touch. This may involve creating a “base camp” for the group, for example at a specific location in a retail area, where members of the group who arrive at the base camp no earlier than a set time and no later than a set time can earn rewards or discounts for spending money in the retail area (e.g. meet up at the airside café between 1 and 3 hours before your flight and enjoy a 25% discount on hot beverages). Furthermore, by interacting with kiosks, group members can view the location (or expected time of arrival) of other group members. This type of group connection would be established by a group leader entity registering with the system, and asking the system to invite other group members to join and connect.

It can be seen that the provision of features which are of use to a particular customer base may help to increase the speed of adoption of the present invention.

As a further example, the entities may be able to send “Multimedia Messaging Service” [MMS] or SMS between each other using the system as a mailbox. This may be useful for people who are in groups or who want to connect but are unsure of what the other people in the group look like to take pictures of themselves using their mobile phone [or kiosk or PC] based digital cameras and to broadcast the said picture to selected or all members of the group or to the person that they wish to meet.

The Connection Engine preferably operates with the “one-click” identity established by the tracking of the entity using the Connection Engine (e.g. using the DDID described below to provide a high degree of certainty that the person using the Engine is whom they say they are).

Further the Connection Engine may operate in conjunction with a Reward Engine to allocate rewards to entities using the Connection Engine, and to allocate charges for use of the Connection Engine to the reward pool.

The Connection Engine preferably also operates in conjunction with the Reward Engine and/or Conversion Engine to use the travel information, breadcrumbing tracks, or planned travel path widths for the participating entities to establish appropriate places and times for meetings, and optionally to adjust that information, tracks or path to provide for a connection between the participating entities. Apart from these interactions, the Connection Engine can be created using existing methods and systems for MoSoSo/Social Networking software, for example as used in Dodgeball (www.dodgeball.com) or LinkedIn (www.LinkedIn.com).

Passengers can use their mobile phones (SMS/MMS or voice), their system web account or other devices such as kiosks or other network connected devices to have an update on their Connection Engine, Reward Engine or other system engine status as well as their flight and other in airport or airlines special offers, vouchers or information relevant to them.

By using the Connection Engine to arrange meetings, a user may increase their Reward Potential. The charges for use of the Connection Engine may be at least partly used to increase the size of the reward pool. Consequently, by making greater use of the facilities offered, a user can increase their chances of winning.

### Examples of Reward Travel Profiles, Target/Detection Zones, Breadcrumbing Tracks and Other Parameters:

The following description and the accompanying Figures give non-exhaustive examples of Reward Profiles in combination with Travelling Entities, Actual/Planned Breadcrumbing Tracks, Target Zones and Detection Zones.

Each Reward Profile is defined by an animate object (e.g. a retailer who wants the passenger to spend as long as possible in his/her facility, the airline operator who wants the passenger to be in the departure lounge as early as possible to avoid late departures due to late arrival of passengers, the airport operator who wants the passenger to relax and spend as much time in their facility, etc.) or an inanimate object (e.g. an automated system which changes Reward Profiles associated with the travelling entities over time because of changes in operational conditions along the planned or actual Breadcrumbing Track, changes which would then impact the incentive provided for someone to reach a destination at a given time; a software agent or software programme which operates in a device; etc.). It is also possible for the passenger him/herself to define a Reward Profile, for example for the purpose of betting (e.g. by defining a profile on a trip that that passenger thinks they can make but others do not and will bet against accordingly).

If a travelling entity “falls” outside of, or enters into, the Reward Profile, one or more Reward Functions are applied to that entity's Reward Potential which may increase, leave unchanged or decrease that Reward Potential.

For instance, FIG. 1 depicts the scenario of an airline operator who wants a passenger to arrive in the departure lounge as early as possible; an airport operator who wants passengers to arrive as early as possible to take advantage and spend in his/her retail operations; or an event organiser such as a sport event/theatre event/home party who is happy for their ticket purchasers/guests to arrive as early as they wish but no later than a particular time.

For simplicity the travel profiles in FIGS. 1 to 5 are shown in a single dimension, with travel along the x-axes from left to right. The Reward Profiles in the Figures are therefore illustrated on the y-axes. In FIGS. 1 to 5, the travelling entity is shown by reference numeral 1, the Reward Profile by reference numeral 2 and the Breadcrumbing Track (the path/distance traveled by one or more Animate Entities on their way to/from Event(s)/Connection(s)/Meeting(s)/Event(s) Area(s)) by reference numeral 3.

Accordingly, in FIG. 1, at time t=t1, the Reward Profile 2 extends along most of the track, and therefore the entity 1 at some distance from the end of the track falls within the Reward Profile 2 and will have their Reward Potential adjusted accordingly.

At time t=t2, t2>t1, (lower graph), the Reward Profile 2 has shifted to the right, as there is a much smaller part of the track that the entity 1 can be in to be capable of reaching their destination by the target time. Therefore, in this example profile, only when an entity 1 is close enough to the destination to be capable of reaching it by the target time will they fall within the profile 2 and have a positive reward function applied to their reward potential.

Each travelling entity may travel according to different time coordinate systems. In addition, none of the profiles (Breadcrumbing Track, Reward Travel Profile, etc.), Detection Zones nor Target Zones need to be continuous/contiguous or smooth as depicted in the Figures. Indeed, they can be of any geometry/logical function, either continuous or discontinuous/interrupted (e.g. a set of successive zones where at least one zone is outside of the Event Area).

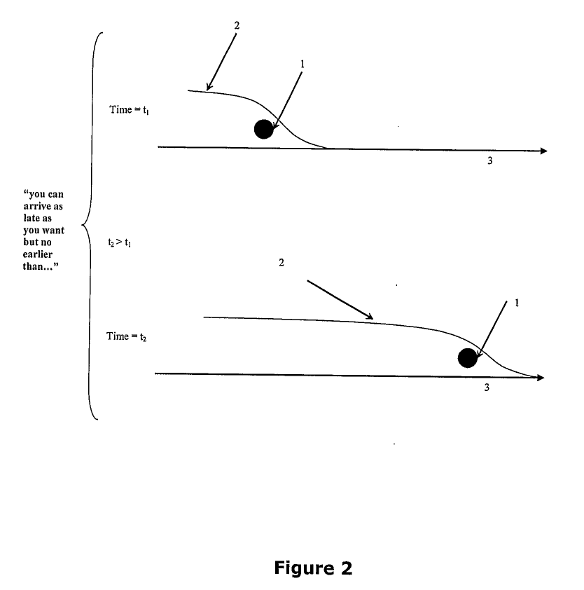

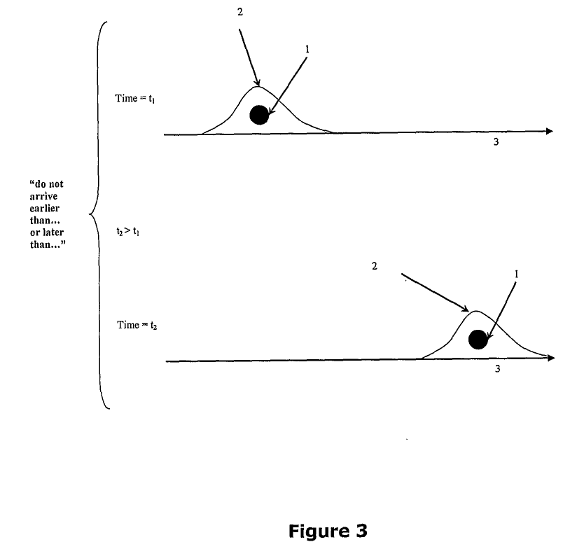

FIG. 2 depicts a situation where, for instance, a person can arrive as late as it wishes to an event (such as a party at someone's house) but not earlier than a particular time. For passengers, this may be the case if weather troubles or air traffic control issues have created a real overcrowding issue at the airport. The airport operator thus has the ability to issue warnings to the passengers and inform them that they may wish to consult their updated Reward Travel Profile (or alternatively or additionally are provided with it in the same warning), which may, for example, have changed from that depicted in FIG. 1 or 3 to that of FIG. 2.

Consequently, the Reward Travel Profile 2 of FIG. 2 is configured so that the Reward Function is applied to entities 1, which are considered sufficiently far removed from the start time of the Event/the departure time to not be in danger of reaching the Event/departure area too soon.

Although it is possible for entities 1 which are “too close” to the destination to delay their progress so that they arrive on time, the system applying the Reward Profile of FIG. 2 does not reward such entities since they may be causing congestion by being too far ahead of their “ideal” track to the destination.

FIG. 3 depicts the most common situation of neither arriving earlier than a particular time nor later than another time. It can be seen that the reward profile 2 here effectively combines the two ends of the reward profile of FIGS. 1 and 2, and is a “closed” profile compared to the “open” profiles of those Figures.

For example, in the situation of using the Connection Engine to help a group of leisure passengers connect and meet up at an airport, the reward profile could be configured such that the group is encouraged to be at a “base camp” zone (a retail area) between 1 and 3 hours before their flight, and the reward is a 25% discount of purchases in this retail area. In one embodiment, this offer could be made to the passengers as they register for the system, where the group leader provides the names of other entities within the group and the email address or mobile phone number of said entities, the system then sends an email or SMS text message to the entities within the group asking them to if they want to join with the promise of the retail discount (thus providing an answer to the “What's in it for me” question, and potentially increasing exposure to and uptake of the system).

The Reward Profiles 2 of all of FIGS. 1 to 3 are “positive” reward profiles, in that the Reward function associated with each profile is one which increases the reward potential of entities falling within it. A similar result could be achieved using “negative” reward profiles which have an inverse shape to those shown, and which have associated reward functions which penalise an entity 1 (by reducing its reward function) falling within them, or reward entities falling outside them.

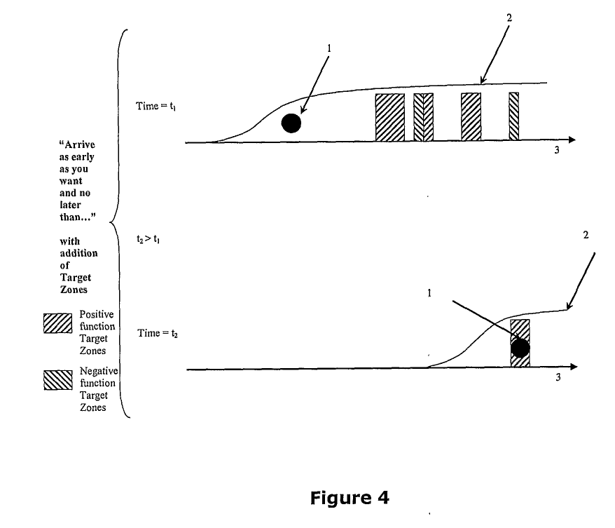

Note that, within or outside of any particular Reward Travel Profile, areas can be defined (e.g. at the maximum height of the Gaussian distribution curve depicted in FIG. 3 or as depicted in FIG. 4) in which, although the entity does not strictly fall within (or outside) the Reward Travel Profile and is not as a result being rewarded/penalised, the reward potential of the entity will nonetheless be increased/decreased. For instance, in the Reward Profile 2 depicted in FIG. 4 (t₁), a passenger is generally rewarded for arriving as early as possible to his/her destination. However, the passenger will also be rewarded or penalised for particular actions performed during the journey to the destination, e.g. rewarded for spending time and/or money in a selected petrol station; penalised for spending money in another retailer; penalised for speeding on the motorway; rewarded for proceeding swiftly through the queue at tunnel Z; rewarded for spending time and/or money in retail locations once they have arrived at the airport; and/or not rewarded for arriving too early in the departure lounge (which results in the passenger just sitting there not spending elsewhere). Accordingly, in FIG. 4, t₂, the Target Zone locations have been updated. For instance, this simplified profile may represent an airline operator who wants the passenger to be remaining in the departure lounge at a particular location just prior to departure and has consequently defined a Positive function Target Zone in that area.

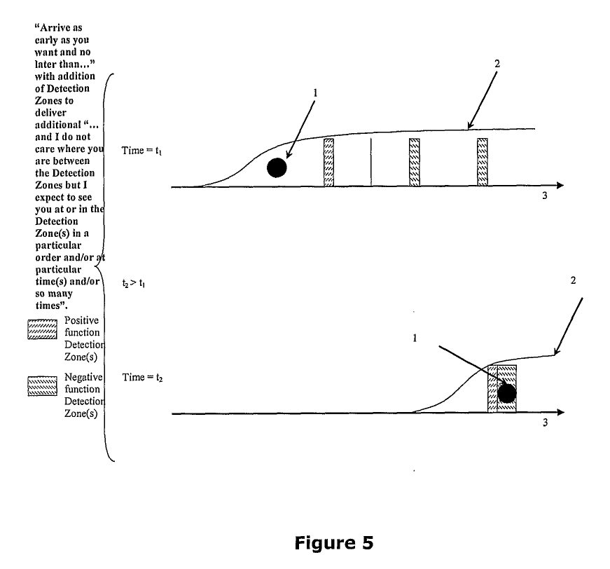

Detection Zones are introduced in FIG. 5. Such zones are relevant if the system only requires or passengers to declare their position or accept to be tracked at particular locations along the way. The detection zones could be time and/or space defined, or indeed, just punctual or line defined (e.g. a line across the Breadcrumbing Track of the travelling entity). As for the Target Zones, the location, sizes and shapes of Detection Zones can change or be modified over time (e.g. as shown in t₂ of FIG. 5).

FIG. 6 depicts a more realistic three-dimensional track for a travelling entity. Reward Profile 2 is similarly three-dimensional. Here, the actual 3-6 and planned 3-6′ Breadcrumbing Tracks allow any entity (including inanimate objects, such as the system itself) to set new parameters which may impact the reward potential of the travelling entity. For instance, the airport operator may know that one of the approaches to the airport is closed due to some infrastructure works. As a result, the operator may wish to discourage passengers from travelling through that area whilst on their way to the airport. This can be achieved by placing Detection Zones in that area and providing positive Target Zones on alternate routes to provide an incentive for passengers to take the alternate routes and be tracked to confirm that they have taken a particular route.

A Travel Path Width 4-6 may be used to define a distribution curve or range of locations over which an entity is still deemed to be travelling along the correct route so as to avoid excessive interactions between the system and the travelling entity, thereby reducing network traffic. The Travel Path Width may be variable with time.

For a party or amusement park, the operator or customer may actually wish to define tortuous routes (Breadcrumbing Tracks) superimposed with Target and Detection Zones with varied Reward Travel Profiles to make the movement of their guests/customers a game which allows them to manage their guests/customers more effectively.

FIG. 7 depicts a “plan” view of two different entities 1a and 1b travelling towards a common destination. They may know that they will share the same end point 5 and may be Animate or Inanimate Objects (e.g. a passenger and his/her luggage travelling by another means of transportation two different passengers who know each other). Here, the two Travelling entities have different Breadcrumbing Tracks, may have different Time-Coordinate Systems 7a and 7b and/or Reward Travel Profiles (not shown), may go through a range of Target Zones/Detection Zones (not shown).

In the majority of situations, the entities will not know of each other's existence, for example in the case of passengers aiming to travel on the same flight.

The incorporation of the travel profiles of a large number of travelling entities in the single system allows further features, such as the ability for an entity to place a bet on the movements of another entity, for example whether that entity will reach their destination or Event Area on time, or within a particular time range.

The location and size of the destination or Event Area may change over time e.g. two people may aim to meet in a pub, location of which changes over time: e.g. “meet at White Horse Pub until 19:00, then Red Horse Pub thereafter”. A breadcrumbing track 1c of the event may also exist and have its own Time-Coordinate System 7c.

FIG. 7 shows a number of zones Z1 to Zn. These zones are illustrated in FIG. 7 as concentric annuli for convenience, but in reality could take any shape depending on the configuration of buildings or areas of interest. In particular zones may be isolated islands and there may be several pockets of zones within zones.

Two passengers (not shown) make journeys through the zones to the departure area, as illustrated by the tracks.

For each zone, the local physical distance which has to be covered by a passenger to pass from the previous zone to the next zone (D1 to Dn respectively) is either known, or can be calculated by the system embodying the invention as a function of one or more of the travelling behaviour of the passenger or luggage, local prevailing conditions and the required or preferred paths through that zone.

As a consequence, the total distance (TD1 to TDn respectively) between the passenger and/or luggage in a particular zone and the departure area is also known, or can be calculated by the system embodying the invention.

A vehicle may be scheduled to leave from a departure area, which may be a specific point in Z1 as shown in FIG. 7, or in alternative embodiments may be set up as Z1 itself, at a well-defined time. An object is to ensure that passengers, luggage or matched combinations, as appropriate of the two arrive at the vehicle in good time before departure so that there is a high probability of the vehicle leaving at its scheduled departure time.

Since the distances are known it is possible to calculate or estimate the time by which a passenger or luggage must be in a particular zone (Zn), or have crossed from one zone (Zn) to the next zone (Zn−1) such that the passenger or luggage has sufficient time remaining to complete the journey to the departure area by the required time. This estimate can also be based on local flow information such as the length of time it has taken previous passengers and/or luggage to make a similar journey.

All entities and areas/zones can operate on relative rather than absolute time scales and/or location frames.

In defining the parameters in the system of the present invention, all parameters (e.g. Detection Zones, Target Zones, Travelling Entities, Events, etc.) may use object-oriented structures (preferably be defined in a database system), and may have inheritance properties (parent/child characteristics), and any combination of structures within structures.

### Different Engines:

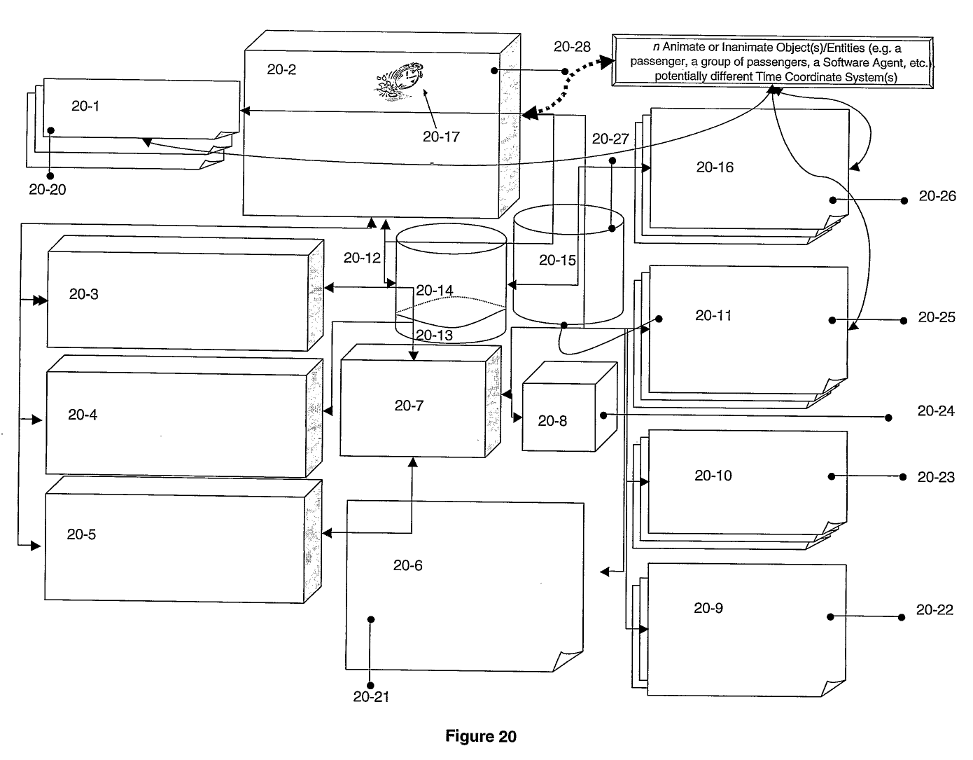

The invention's processes, methods and systems include a range of engines needed to ensure that an entity wishing to use the system can do so securely and in a timely manner. The engines are briefly described below and a possible overview depicted in FIG. 20.

In FIG. 20, the following reference numerals are used:

20-1 are the settings and tables for the Reward Engine(s), Connection Engine(s), Conversion Engine(s) and/or Search and Match Engine(s), and typically include Conversion tables, Connection tables, Regulatory tables (e.g. country specific data on matters such as Data Protection, gaming and betting regulations, etc.), location data and logical operations.

20-2 is the Conversion Engine, which provides Location conversion (from SMS/MMS/LBS/GPS or other absolute or relative location data input(s)), time conversion (e.g. between time zones, relative and absolute time coordinate systems, and can apply nonlinear/linear/discontinuous conversions), reward conversion (e.g. from reward “credits” to actual monetary sums or non-monetary rewards, between currencies or to/from reward programmes such as AirMiles), and conversion of contributions from Connections, Gaming, Reward, other contributions into “credits” in a Reward Pool. The Conversion Engine includes the reference time/coordinate system 20-17.

20-3 is an instance of a Reward Engine, which provides rules, processes and methods to match an Entity's location/time with configurations of the Reward Pool and/or the Reward/Connection/Gaming profile(s) of the Entity. This Engine may calculate Reward Probability, allocated pool amounts, etc. This Engine stores Reward Functions, Breadcrumbing Tracks, specific locations (such as target zones) and the logical operators to interpret the rewarding of an entity relative to these.

20-4 is an instance of a Connection Engine, which provides rules, processes and methods to match an Entity's Reward/Connection/Gaming profile(s) with the Entity's location and is linked to an instance of both the Reward Engine and the Search/Match Engine, and provides Connections between Entities who are looking to meet.

20-5 is an instance of a Gaming Engine, which provides rules, processes and methods to match an Entity's Reward/Connection/Gaming profile(s) with the Entity's location and is linked to an instance of both the Reward Engine and the Search/Match Engine, and provides services such as games for an Entity to participate in, betting services, odds, etc.

20-6 are the Reward Profiles of Entities. These include information such as an Entity's age group (which may be linked with the Regulatory table, and affect the type of reward permitted for a particular entity), Personal Travel Reward Profiles, Personal Reward Functions, Personal Reward Potentials, Personal Travel Path Widths, Personal Compliance Profiles/Reward Probabilities, Personal Target Zones, Personal Detection Zones, Personal Target Breadcrumbing Tracks, Tracking system opt-ins (e.g. LBS), Reward Potential, Reward Credits, Reward Pool share, etc.

20-7 is an instance of a Search/Match Engine and of a Billing Engine, which provide rules, processes and methods to the Reward/Connection/Gaming Engine instances.

20-8 is an instance of a Reporting Engine, which provides data mining facilities to operators and to subscribers, which may include real-time reports, specific reports tailored to a particular operator/subscriber and other data search/reporting facilities and operations.

20-9 are the Gaming Profiles of the Entities, and store information such as: Age Group information (which may affect an Entity's ability to participate in certain gaming functions, according to the Regulatory table or other system rules, or to receive particular rewards), Personal Gaming Profiles, Personal Gaming Functions, Personal Gaming Potentials, Bet records, Participation in different games, as well as information relevant to particular games, such as type, size (monetary and number of participants), availability (time/location/type or class of Entity), etc.

20-10 are the Connection Profiles of Entities, and store information such as and Entity's likes, dislikes, personal information (e.g. school, business field/specialism, business/social interests, sex, preferences), information about the type of people that the entity would like to meet, etc.

20-11 are the Personal and Group Profiles of Entities, and store information such as an Entity's name, address, account details (bank or PayPal™), contact details, age, nationality, country, state or other location information, mobile device information, Device Digital ID (DDID), Additional Identity Authenticator, services that an Entity has subscribed to (e.g. Connection, Gaming, etc.), type and length of any opt-in features, location information, etc.

20-12 is the Reward Pool database, which stores information about the size and contents of the different Reward Pools available/accumulated at any time and typically consists of both an allocated pool 20-13 and an unallocated pool 20-14.

20-15 is an identity database, which provides rapid (e.g. “on-click”) access to a particular entity's data based on a single identifier such as DDID or AIA.

20-16 are the configurations of the Reward Pools, and store information such as Reward Travel Profiles, Reward Functions, Reward Potentials, Travel Path Widths, Target Zones, Detection Zones, Breadcrumbing tracks, Standard unit information (e.g. Credits), Standard prize information (cash, reward scheme information, etc.), etc.

The above configurations, databases, tables, and instances may have parent/child configurations with inheritance properties as desired and may be guided or populated initially from default configurations, by software agent, or by any Animate or Inanimate Entity.

20-20 to 20-28 are Application Programming Interface (API) links from the above Engines/Profiles/Databases.

20-20 links the settings and tables 20-1 to other instances or other databases, clients or servers of the system, and to other inputs such as location data from a mobile network.

20-21 links the Reward Profiles to other databases of gaming/betting/other profiles.

20-22 links the Gaming Profiles to other databases of gaming/betting/other profiles.

20-23 links the Connection Profiles to other connection databases, such as MoSoSo, social networking, dating, business networking/meeting, etc.

20-24 links the Reporting Engine instance to external reporting functionality/information.

20-25 links the Personal/Group Profiles to other databases of Personal/Group profiles/information.

20-26 links the Reward Pool Configurations to other databases of Reward Pools, or other reward databases such as loyalty card schemes, AirMiles, etc.

20-27 links the Identity “one-click” database to other “one-click” databases.

20-28 links the Conversion Engine to other Conversion Engines.

All of the above described APIs go through PKI/PGP, VPN, SSL, Domain Key/firewall, or similar authentication and security protocols and checks.

As shown in this figure, the thick, dotted and double arrowed line shows the technical connections that the invention has with other entities, animate or not. This includes SMS/MMS/Voice/data/etc. (inbound/outbound e.g. a passenger provides the system with a code that gives his location, or use SMS/Voice for chats with other users of the system, or use SMS/MMS/etc. to find what is the status of their Reward Probability/Compliance Factor, Reward Credits, Reward Potential, etc.). Each entity thus interfacing with the system may be authenticated via Digital Device ID (DDID) which is linked with the Identity “one-click” database 20-15 which holds a dynamic ID for each entity which, unlike current prior art may be linked to the DDID of the device (e.g. an ID of an entity's mobile phone); augmented with added security (e.g. biometric/biophysical, etc.) which may be used to uniquely link a person with a device (e.g. the Additional Identity Authenticator (AIA)), and which may be further augmented with time and/or location information (e.g. this ID is only valid between 08:00 and 22:00 and only within the M25 boundaries).

The rest of the possible interactions between the different Engines, configuration files and other reporting tools/API to other third party systems and databases can be found in FIG. 20.

For instance, a user wishes to confirm his Reward Probability and Ahead Factor to check if he is about to win a prize. For example, he may contact the system through a web (WWW) browser before departure and through his mobile thereafter once travelling. If travelling, he may send an SMS to the system. Through searching the Personal/Group Profile of all the entities registered with the system, the search engine 20-7 would take care of finding the relevant person. This can then trigger an ID check (by searching the “one-click” database 20-15) and a billing engine 20-7 run to charge the entity's account accordingly.

In embodiments of the invention, the SMS triggers an LBS track on the entity, which gives the location of the traveler to the Conversion Engine 20-2. Alternatively, if the passenger does not want to be automatically tracked, the passenger has the option to send SMS/MMS messages with codes indicating where they are. The Conversion Engine 20-2 converts such codes, whether received from the LBS track or separate messages into a location in a coordinate system recognised by the system.

The conversion engine 20-2 interfaces with the Reward Engine 20-3 which, with the ID of the traveler obtained earlier, communicates with the Connection 20-4 and Gaming Engines 20-5 to check if, when matched with the relevant profiles 20-9 to 20-11, the reward profile 20-6 of the entity should be adjusted or if new Credits can be apportioned to the entity. A comparison of the newly calculated Reward Probability of that traveler is made with all the other users registered for that trip, or the relevant pool of “competing” entities, and sends an SMS back to the traveler's mobile phone with his Ahead Factor. The Reward Pool 20-12 is updated with the additional amount of unallocated credits (cash taken from the billing engine duly converted by the Conversion Engine 20-2 into Credits to ensure that such rewards can be ported to other currencies such as airmiles or other cash or non-cash prizes).

The system may operate to place limits on the number of people joining the system for any particular event, and may dynamically update these limits.

Furthermore, time limits may be placed on entities preventing them from re-joining the system for any particular event, for example if they have not registered within a particular time period prior to the event, have not updated their location within a predetermined time frame, or if they have voluntarily left the event (e.g. by sending a message to the system).

An entity joining the system may elect to join any, some, none or all the engines (e.g. participate in the features offered by the Connection Engine but not those offered by the Reward Engine).

The engines and overall system/methods/processes preferably run in a peer-to-peer arrangement and/or a client/server arrangement. If the system runs in a peer-to-peer arrangement, ID, billing and other central features will run on one (or more) of the devices to ensure that the Reward Pool is correctly updated on each peer device.

There may be multiple instances of each of the engines, which may be located on one device or on different devices, the latter preferably being interconnected, e.g. by a network. The engines of the present invention may be implemented in software or hardware, or a mixture of the two, but are preferably implemented in software for ease of updating.

For the purposes of the system operator, the engines, software agents, Animate/Inanimate Entities, and all other parameters used in a particular embodiment of this invention leave data trails for audit purposes which can be collected, reported upon and monitored/reviewed either on the fly or at a later date (e.g. via a datamart system).

### Reward Engine

The primary function of the Reward Engine 20-3 is as a reward aggregator. There is the above description for additional details. Accordingly, it updates the Reward Pool(s) for each group of entities, and the reward profile for each entity, using inputs giving data on the relevant entities, billing data, travel profiles, reward functions, actions of entities (e.g. retail purchases).

By connection with external data feeds (e.g. weather, traffic condition, etc.), the system and its engines may be arranged to take account of local conditions experienced by entities (e.g. if it rains in a particular location, such as the motorway to the airport, and the entity still makes it on time, the Reward Potential for that entity may be updated using a specific or general Reward Function for that event/condition, which may then look in the Reward Pool 20-12 if an umbrella retailer has an offer on umbrellas and add this to the Reward Potential for the entity experiencing those conditions and alert the entity of that fact. Alternatively or additionally, the Connection Engine 20-4 may suggest that entities which have arranged to meet in a particular location, which is sheltered, due to the rain (or other weather condition—e.g. outside location if temperature above a certain level).

### Validation of Location

If the user does not want to have his location validated automatically by an LBS track or GPS or other third party validation method such as interacting with a trusted person or device (such as a well defined kiosk), and instead only reacts intermittently (e.g. by sending some SMS/other message to the system informing the system of his location), then he is likely to be contributing less to the Reward Pool 20-12 than entities who are being tracked continuously. He is also contributing less in the way of useful data to the system.

Accordingly, the system may be configured so that the Reward Function for that entity does not increase his Reward Potential to the same extent on compliance as the Reward Function of an entity which is being continuously tracked, thereby providing a weighting of the Reward Potential.

### Check of Reward Potential

A user can check at any time what his Reward Potential (e.g. Reward Credits may ask what this means in terms of cash, other rewards, etc.) is.

The user can check at any time what his Reward Probability is (e.g. a user may send an SMS/MMS, check a web site and request that the system inform him of his Reward Probability). If a charge is made for this service, the Reward Pool may be increased accordingly, and since the user is contributing further to the Reward Pool (and potentially to the operator's income), a Reward Function may be applied to increase the user's Reward Probability accordingly.

### Example Implementation of an Embodiment of the Invention for Passengers and Air Transportation

This example shows how a reward pool accumulates, and how a user may come to win that reward pool (or a share of it).

Taking as an example a facility such as an airport has 40,000 passengers per day, 10% of people use the invention and register with an SMS message (cost to user: network charge+50 pence (“p”)—the denomination of this example is pounds sterling, but the example can be equally applied to other currencies—of which 20% goes to the network or other operator such as content providers) and get two system SMS back to remind and then confirm participation (each costing the system operator 4 p).

### Contribution to Reward Pool:

(40,000×0.1×0.5×0.8)−(40,000×0.1×0.04×2)=+£1280

20% of the 10% participating do not want to be tracked automatically but want to participate and send 5 SMS (at network charge+50 p, less 20% charges) to give their location (either by return LBS for that SMS or by sending a code which describes where the are), each receive an SMS message to confirm receipt and give them their Compliance Factor (at 4 p cost to system operator each).

Contribution to Reward Pool:

(4,000×0.2×5×0.5×0.8)−(4,000×0.2×0.04)=+£1568

80% of the 10% use the automatic method and have 3 tracks (at 10 p cost to system operator each).

Contribution to Reward Pool:

4,000×0.8×3×0.1=−£960

5% of the 10% bet £5 to buy more reward potential through their mobile (less 20% to the service provider) and receive one SMS message each (at 4 p cost to system operator) to confirm receipt.

Contribution to Reward Pool:

(4,000×0.05×5×0.8)−(4,000×0.05×0.04)=+£792

5% of the 10% enable the connection engine through their mobile sending 1 SMS (at £1 charge less service at 20%) and each get a confirmation message (at 4 p cost to system operator). 20% of the those enabling the connection engine get a hit message (each at 4 p cost to system operator) and send one SMS to check whom it is (at 50 p charge less 20% network service charge) and 50% of those enabling the connection engine each have 10 SMS chats (at 25 p each less 20% network charge).

Contribution to Reward Pool:

(4,000×0.05×1×0.8)−(4,000×0.05×0.04)−(4,000×0.05×0.2×0.04)+(4,000×0.05×0.5×0.8)+(4,000×0.5×0.05×10×0.25×0.8)=+£430.4

A retailer gives vouchers for 20% off PC worth £1000.

Contribution to Reward Pool:

0.2×1000=+£200*

(considered separately as the retailer's Terms & Conditions state this is not cash convertible)

A retailer also has a special offer for that day in that for every £10 spent in the shop by people using the invention, the retailer contributes £1 to the Total Reward Pool. £5,000 was spent by the participating users.

### Contribution to Reward Pool:

5,000×0.1=+£500

The betting passengers (5% of the 10%) and other betting entities trade £4000 worth of betting on, for instance, the odds of the plane departing within 15 minutes of the highlighted departure time, each bet using one premium SMS to place (at 50 p less 20% network charge) and get one SMS back (at 4 p cost to system operator) for confirmation of placing the bet. The other betting entities may or may not be passengers travelling that day. For example, non-travelling entities may be system users staying at home, travelling on a different flight or members of an airport staff incentive scheme. We assume that the system takes a 1% management fee and that the bets are net zero for the system (which may not be the case) i.e. all the passenger who have bet share all the betting reward pool minus the management fee and service charges.

Contribution to Reward Pool:

4,000×0.05×0.5×0.8−(4,000×0.05×0.04)+(4,000×0.01)=+£112

In this instance, the Total Reward Pool for that day is:

£3,722.40+£200 non cash

In addition, system users who pay annual subscriptions and who want to benefit from paying a yearly fee to cover a number of flights per year without having to register for each flight could see their fees aggregated in a yearly Reward Pool which can then be divided, for instance, per flight, per hour or per day. For instance, for an airport with 20,000,000 annual passengers, let us assume that 0.5% pay an annual subscription charge of £10, that such passengers actually travel 10 times a year and use the fully automatic LBS track based reward engine (2 tracks at 10 p cost each) and each receive one SMS message at a cost of 4 p to remind them when it is time to go from home, the actual reward pool is thus augmented by:

20000000×0.005×(10−10×2×0.1−10×0.4)=£400,000 Reward Pool per year, which is a further £1,096 per day which could be added to the above £3,722.40 cash daily Reward Pool mentioned above. For the purpose of the following description, we assume that the above £1,096 amount is not included in the daily reward pool although it could be.

The system operator determines how this Reward Pool is allocated (which will usually be in a standard, publicised manner).

For example, if it is assumed that every flight has 130 passengers and rewards are only awarded to passengers departing from the airport only, the rewards could be allocated as £3,722.4/(40,000/2/130)=˜£24.2 for distribution to one passenger per flight who complied the best with the requirements of the system in relation to time/location/arrival to departure (i.e. has the highest Compliance Factor). Alternatively, the rewards could be allocated as ˜£242 for one passenger every ten flights. Alternative arrangements could allocate a share of the reward pool every hour, or only on certain days (e.g. if the airlines and/or airport wanted to particular days of the week for flying from their airport using an airline). Similarly, certain times/flights could be allocated a greater share of the reward pool to encourage people to use the system at those times.

For instance, using the conversion engine, an airline could have access to the whole pool, pay themselves, say, £24.2 less a system management fee and give the passenger with highest Compliance Factor for the flight an equivalent number of Airmiles or points.

Any passenger that has the highest compliance factor at that time can then receive the retailer's special offer against redemption in the airport's retailer facilities, high street facilities or via post depending the passenger's desires.

Now, how the Compliance Factor (CF) or Reward Probability (RP) of the winner (i.e. closest to “1” and/or best trip process compliance) may be calculated:

The various aspects of the Reward Function (RF) of each Passenger may be set by retailers/airport operator/airline operator, etc. In the present example, the following factors apply:

a) if the Passenger is 10 mins early or 10 mins late at any point along the line against the ideal trip, then RF reduces CF by 20% (example of use of Reward Travel Profile of the type described in FIG. 3);
b) if the passenger does not return their RFID activated boarding card at the departure [see GB2408617] gate, the RF applies NULL to CF which then becomes zero (example of Target and Detection Zones, see FIGS. 4 and 5);
c) if the passenger goes through the security queue when it is longer than 5 minutes in time, RF reduces CF by 10%;
d) the passenger can buy increases in CF, ±1 for each 1% increase of CF;
e) if the passenger spends £10 in retail in participating stores the RF increases CF by 2% and further 2% for every additional £10 (example of Target and Detection Zones, see FIGS. 4 and 5);
f) if the passenger is not at kiosk 5 in the airside retail by 16:00, the RF will decrease CF by 5% (example of Detection Zones, see FIGS. 4 and 5);
g) if the passenger arrives at gate late by more than 5 minutes, RF decreases CF by 40% and 40% further for every additional 5 minutes delay down to CF=0;
h) if the passenger spends more than 10 minutes in retail, RF increases CF by 2%;
i) if the passenger spends more than 10 minutes in the seating area without going to the retail area, the RF decreases CF by 2% (example of Breadcrumbing Track, see FIGS. 6 and 7);
j) each enquiry via a mobile phone (SMS/MMS/GPRS, etc.) to the system increase CF by 0.5%;
k) each enquiry via a kiosk or PC, etc. (i.e. no additional charges added to the Reward Pool) will not see the CF change;
l) if the passenger uses the north road toward the airport (where there are roadworks) CF is reduced by 5% (example of Breadcrumbing Track, see FIGS. 6 and 7);
m) if the passenger uses the Connection Engine, RF increases CF by 5%;

However, in order to be “fair” to participating customers, the system is configured such that none of the methods of “buying” increases in CF will prevail over the CF of someone who is completely on time everywhere and has perfectly complied with the required process throughout. In such a case the Reward Potential may either be shared between the compliant passengers or allocated (at random) to just one of the parties, depending on how the Reward Engine is configured.

Accordingly, for a winning passenger (taking the above scenario, with the calculated reward pool and distribution of a single reward per departing flight, but with all departing passengers on the flight in question having signed up), the following activities take place:

t=0—the passenger leaves at the time when the system tells him/her to and accepts to be tracked->Compliance Factor set to 1 at that time (start of trip to airport). We assume that all passengers do the same, hence the Ahead Factor [AF]=0;
t=t1—the passenger is late by more than 10 minutes at a detection point not far from the airport, CF=0.8, no other passenger is late or has been late anywhere else, AF=130 (total number of eligible passengers)−1=129 i.e. 129 passengers with a higher CF and therefore more likely to win at the current point in time.
t=t2—the passenger buys 5% of CF, paying £5, CF=0.8+0.05=0.85. Some other passengers are late and went straight to gate in the seating area. As a result AF=42.
t=t3—the passenger is in the airport and on time elsewhere and spends £50 in retail, CF=0.85×(1+0.02)×5=0.935. However, most other passengers are late in the queue and took the wrong Breadcrumbing Track allocated to them (i.e. strayed from their allocated ideal path) and went through the north road towards the airport, so AF=5.
t=t4—the passenger uses the Connection Engine, CF=0.935×1.05=0.982, AF=1 since one passenger has a CF=1 as they have complied with the process entirely (rode the “wave of timeliness” better);
t=t5—the passenger spends more than 10 minutes in retail, CF=0.982×1.02=1 (limited to 1), but still AF=1 as the other passenger with CF=1 has complied better (passenger who bought some reward back cannot prevail over pure compliance with the required tracks);
t=t6—the other passenger with CF=1 fails to return the RFID card on boarding the aircraft, so his/her CF=0, causing AF=0 for the first passenger, who collects the reward of £24.2.

If the final collection kiosk is also an ATM, the passenger can collect their reward there. The passenger could choose not to collect the cash but to reinvest it into their account or another account to go for a bigger prize at a later date.

In its most simple form, all the passenger has to do is to register and accept to be tracked (if using a mobile, via LBS tracks for the duration of the trip for instance, complete control/opt-in from the passenger).

To know whether they are likely to win, the passenger may use an interface e.g. send an SMS from their mobile phone to the system to have receive their current CF and AF factors if they wish to. Each time a person checks “how am I doing?” and/or “how am I doing with respect to other entities” through an SMS/MMS or other premium service (voice or data), they contribute a proportion of the premium amount charged (less network operator charge) to the pool—see above example of a reward pool.

If the passenger does not want to do this, they just have to turn up at the gate on time and return the RFID card. Such passengers may then win although their chances are much reduced compared to passengers who have performed other actions en route to the destination gate.

Each of the interactions between the Passenger and the system can go through WAP/GPRS, voice, SMS/MMS, iMode, 3G, kiosks, EPOS, etc.

In return, the system interacts with the Passenger through a range of protocols/languages, speaker alerts, etc. and gives requested information e.g. AF is x, CF is y but the system also provides travel relevant information e.g. plane delayed, why not spend time in the retail facility in addition to AF is x and CF is y.

The passenger may choose not to collect the reward and let it build over time in his user account to be able to afford more at a later time.

### Connection Engine(s)

The primary function of a Connection Engine is to find likely matches between entities, which have requested to be matched and meet. The Connection Engine either independently, or using a Search Engine to determine potential matches.

For instance, a first person may wish to meet another person for business purposes. The first person indicates his desire for such a meeting, for example by setting a flag on his system account through a mobile phone connected through GPRS, sending and SMS, calling a call centre representing the system, using a web browser or interfacing with a kiosk which has access to the system.

For example, a traveler knows that he will be travelling through a particular airport on Tuesday at 16:00 and will be there between 14:00 and 16:00. The traveler now requests to meet people who are interested in super computers by sending an SMS to the system indicating his request (identifying the trip, which the system may already be aware of, his particular interest for the meeting, and the appropriate times—note that one or more of these items of information may be stored on the system as part of the traveler's profile). As before, ID functions, billing functions, etc. are run and the Reward Pool updated accordingly. The Connection Engine then uses the Search Engine to find a relevant person. This may be done prior to departure or whilst the traveler is travelling to the airport. Preferably the system updates the traveler as soon as possible regarding potential matches, or their absence to ensure that the traveler can make appropriate arrangements (e.g. request a different search profile before it is too late). If a match is found, the user could take a picture of himself using his camera phone and send it to the system. The system's billing engine and data are updated to reflect this further exchange of data. At that moment, the other person is informed that the traveler wishes to meet him at the airport. Upon arrival at the airport (or earlier if he uses his phone to say “happy to meet” and send an SMS to that effect if from his mobile), the second traveler may use a kiosk linked to the system (e.g. TCP/IP type network), or his own mobile communication device to accept to meet the person and sees the picture that other traveler took earlier. He then can elect to meet the other traveler on the airside of the airport, which is more secure because it is a controlled area and could send an SMS or take a picture and send and MMS to the other person via the system (note that in this arrangement, neither person thus has to know the other person's mobile number since they are recognised by the DDID/other AIA by the system, thereby maintaining security and allowing a person to determine whether they give their contact details to the person that they have met). Again, the billing engine, updates the Reward Pool, Reward Potentials, etc. accordingly.

In a development of the present invention, entities may be provided with the ability to “vote” on other entities whom they consider to be the best “team player” or a particularly deserving entity, e.g. for the usefulness of the meeting with that entity. By doing so, the Reward Potential and/or Compliance Factor of the entity receiving the votes may be increased.

Combinations of the Connection Engine(s) and Billing Engine(s) with the fact that wherever possible, the system converts all the rewards in “Credits” in the Reward Pool(s) may lead to users connecting with each other to use the system as a trading platform (barter equivalent using “Credits” as the currency).

### Gaming Engine(s)

The primary function of a Gaming Engine is to enable entities to make the process of travelling more interesting. The Gaming Engine preferably interfaces with the Reward and/or Connection Engines amongst other engines, as depicted in FIG. 20.

The Gaming Engine provides entities with the ability to place actual bets (e.g. cash) to back or lay a particular outcome. By placing bets (and thereby contributing to the reward pool as the system takes a management or transaction charge on each bet), an entity can increase their chance of winning by increasing their Reward Potential. Although bets may be on any outcome, the system is particularly suited to bets on outcomes of events within the purview of the system.

For instance, a traveler could take a bet on the odds of all the flights arriving within 15 minutes or their due time or on the odds of having rain delaying or not delaying flight schedules for the UK airports, London, airports, etc. over a specified period of time (e.g. a day, a few hours, etc.). The entity could choose to back or lay odds on this event happening. As with the other engines, interactions with the system may be done through a web-based account, mobile phone or other portable device, or a dedicated system kiosk, etc. Similar ID checks, billing runs, etc. are performed as before to update the relevant Reward Pool accordingly.

The Connection and Search Engines are used to connect with other users, either travelling or not (an entity does not need to be travelling themselves to take part in the actions of the Gaming Engine) to create a liquid market and increase the overall prize money available for that event. The Reward Pool may hold this money separately from the Pool available to people who do not use the Gaming Engine. This may be particularly relevant since such money may be subject to specific rules and regulations (see FIG. 20) and in particular may be allocated between Gaming Engine users only.

Each time the users run the system and, for instance, place a bet, a service charge is applied to the bet placed via the Billing Engine. This charge may go into the Reward Pool as prize Credits available to all. If users use MMS/SMS/other premium rate services, the system will, again use a percentage of this surcharge via the Billing Engine to increase the Reward Pool for all.

The Gaming Engine may also be used separately as staff incentive system. For instance, the owner of an airport may seed the Gaming Engine with some cash. If all the flights run smoothly that day, some member(s) of staff users of the system could benefit according to the person who guessed what actually happened on the day (cash prize for instance or a trip) if airport as a whole performed reasonably well.

In a different embodiment, the Gaming Engine may be used in amusement parks. For instance, a limited number of system Gaming winners can be awarded prizes at any time. The primary issue in amusement parks is that of queues and crowd control. Therefore, by using kiosks placed in the park and/or other devices such as the customers' mobile phones, specific prizes, such as access to the rides by bypassing the queues, could be awarded if a customer complies with requests to go to a different ride at a particular time because the one they are at has exceeded its capacity. Alternatively, the system may be configured so that if the user goes around the rides in a particular order and makes it on time to the next kiosk within a set time, they are rewarded (could also work in any other facility such as an airport to entertain children by having a time treasure hunt—find all the kiosks and shops in that order and get a free drink, etc.). The Reward Pool can be used as added profit for the park operator, the system operator, redistributed to the customers, etc.

In a further example, airlines could operate the system to reward their passengers for loading their bags on the luggage compartments quickly (e.g. by not having large hand luggage, etc.) and to offer odds on how long it will take to load the aircraft. The passenger the closest from this time having placed a bet with the Gaming Engine can then be rewarded (for instance on the flight with food, upgrade to business class, airmiles, etc).

### Conversion Engine(s)

The conversion engine ensures that location, time, rewards, etc. are maintained in “currencies” consistent with the system and meaningful to each entity interacting with the system or any instances of the system.

### Billing Engine(s)

The Billing Engine ensure that the correct entity is billed/awarded the correct amount for using the service(s) of the system and, through the Reward Engine(s) in conjunction with the Preference/Profile data, updates the appropriate Reward Pool accordingly (i.e. increases it and/or awards prizes, etc).

### Search Engine(s)

Performs searches for any of the Engines/system requirements.

### Reporting Engine(s)

Allows any authorised entity to create on the fly reports and/or store data for later reporting.

### Devices, Entities and Network:

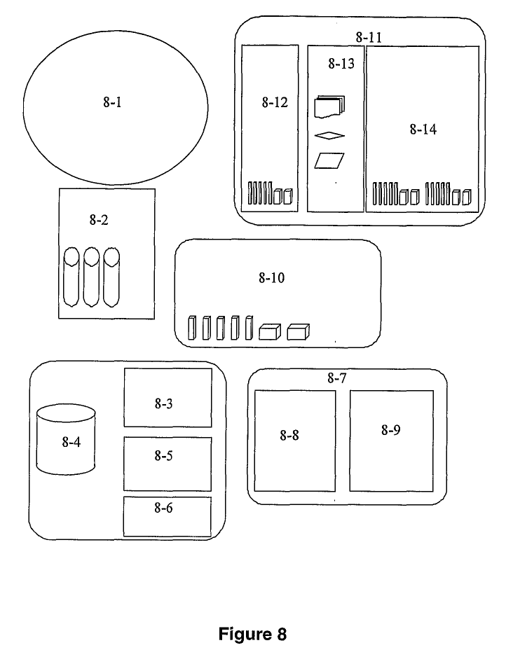

FIG. 8 depicts a range of devices and hardware which may be used the system/process/methods of embodiments of the invention. Although no connections are shown in FIG. 8 between the different blocks, any combination is possible since peer-to-peer and/or client/server configurations are possible.

In FIG. 8, the reference numerals have the following meanings:

8-1 represents the Internet and connections between devices may be wireless or wired, and may use enhanced security features such as Virtual Private Networks (VPNs), firewalls, authentication, DomainKey, PGP, PKI infrastructure, etc.
8-2 represents middleware servers with interfaces to device hardware as required.
8-3 represents an HTTP web server, which provides XML and XSL services as well as acting as an ISP.
8-4 represents Enterprise Java Bean Containers/Servers and may exist in multiple instances.
8-5 represents a .NET server.
8-6 represents other database servers.
8-7 represents other third party interfaces an access, including, for example, traffic management information, weather information, and other content providers (8-8) and LBS track, location information, SMS/MMS/Voice interfaces and synthetic voice systems (8-9).
8-10 represents devices such as kiosks, ATMs, flight information displays, retailer points-of-sale, speaker systems, SMS/MMS gateways and systems, printers, RFID readers/detectors, barcode readers, other sensors, etc., as well as software agents and standard logic.
8-11 represents client interfaces and access, including PC/Internet browser access (thin and/or thick clients, HTML/XML/WAP, Java applets, RSS feeds, etc.) 8-12, other client applications 8-13 and wireless network enabled interfaces (e.g. wireless mobile, WIFI, WIMAX, Bluetooth, mobile phones, PCs, tablet PCs, PDAs, etc., again using HTML, XML, WAP, XML-RPC, Java Script, Java Applets, RSS feeds, and other protocols), such as GPRS, iMode, 3G, etc.

For example, take the example of a passenger travelling to catch a flight. During the planning phase of the trip, he may have used a PC with a web browser or called a call centre to join the system and book the trip. Once travelling to the airport, he may use SMS/MMS (or voice on a hands free car set if travelling by car) to interface with the system. Once in the airport, the passenger may still use his mobile, look at flight information displays linked with the system, talk to people who have access to the system (e.g. staff), interface with kiosks linked with the system.

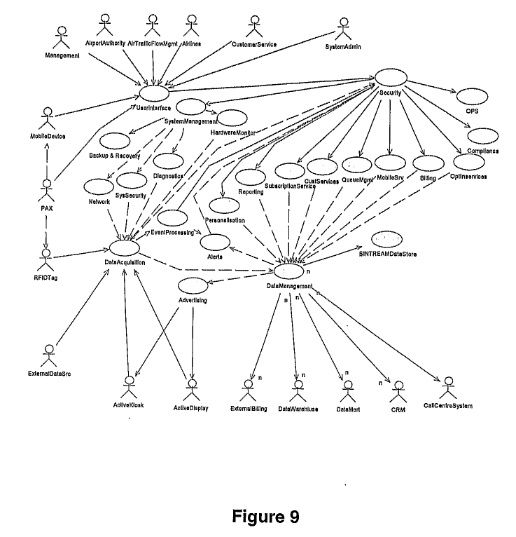

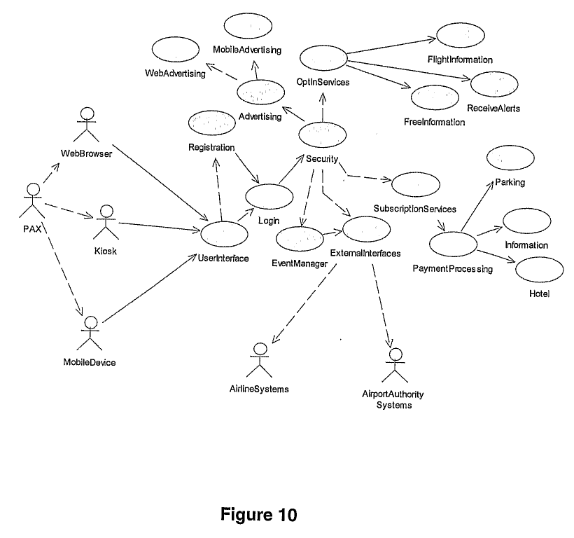

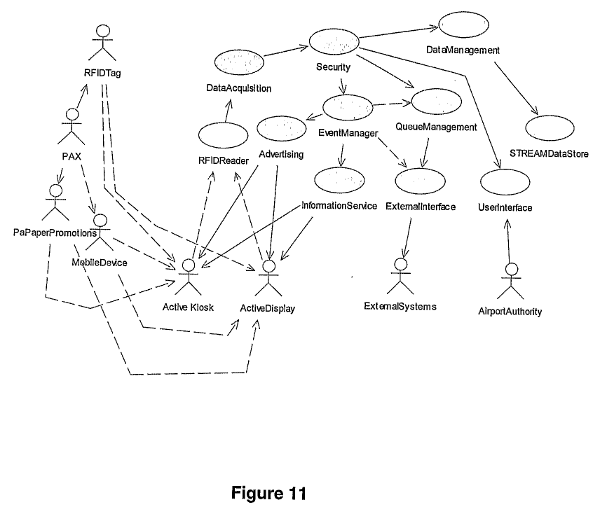

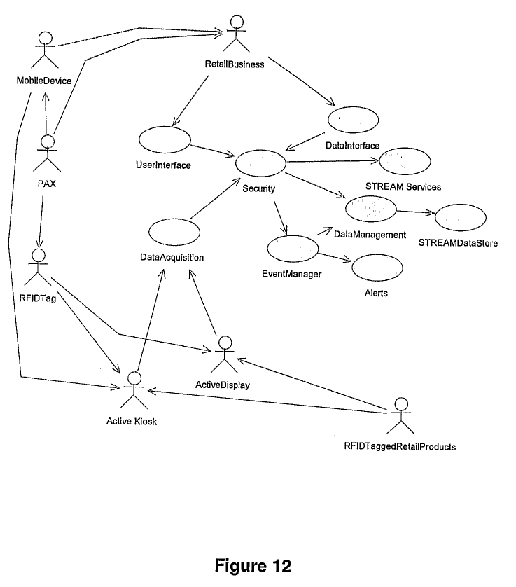

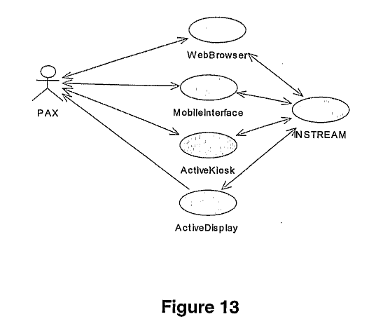

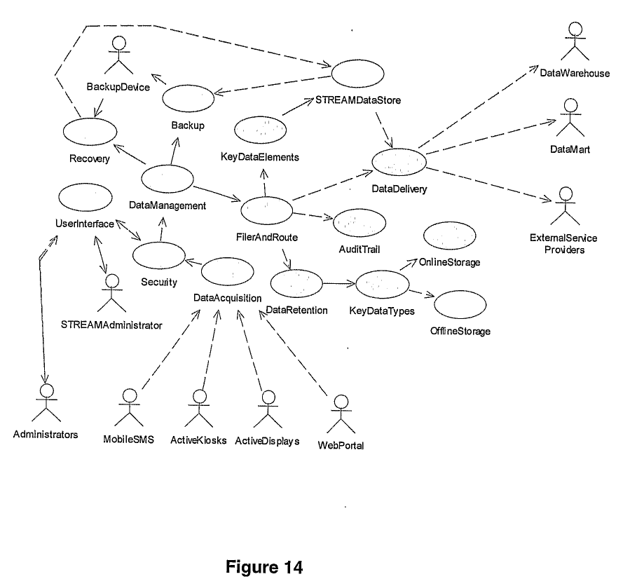

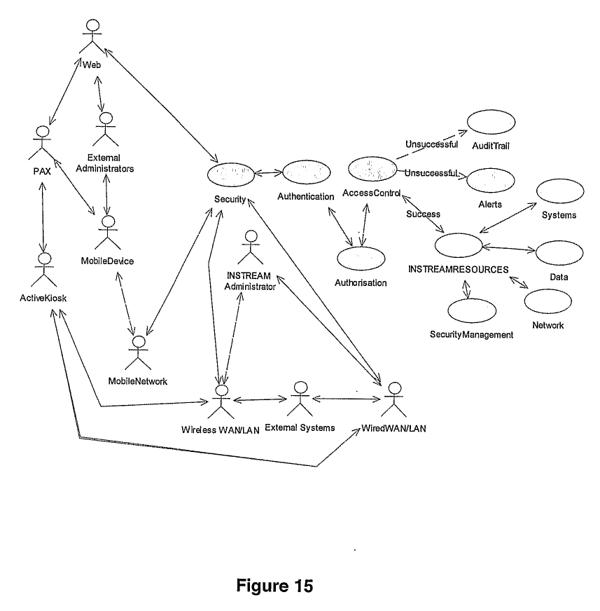

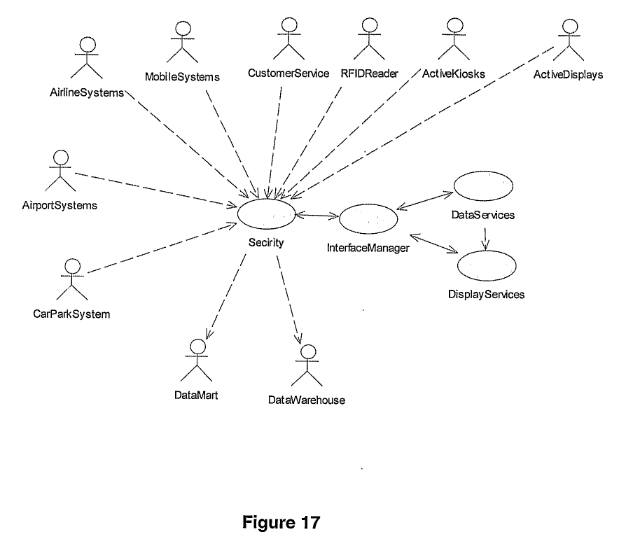

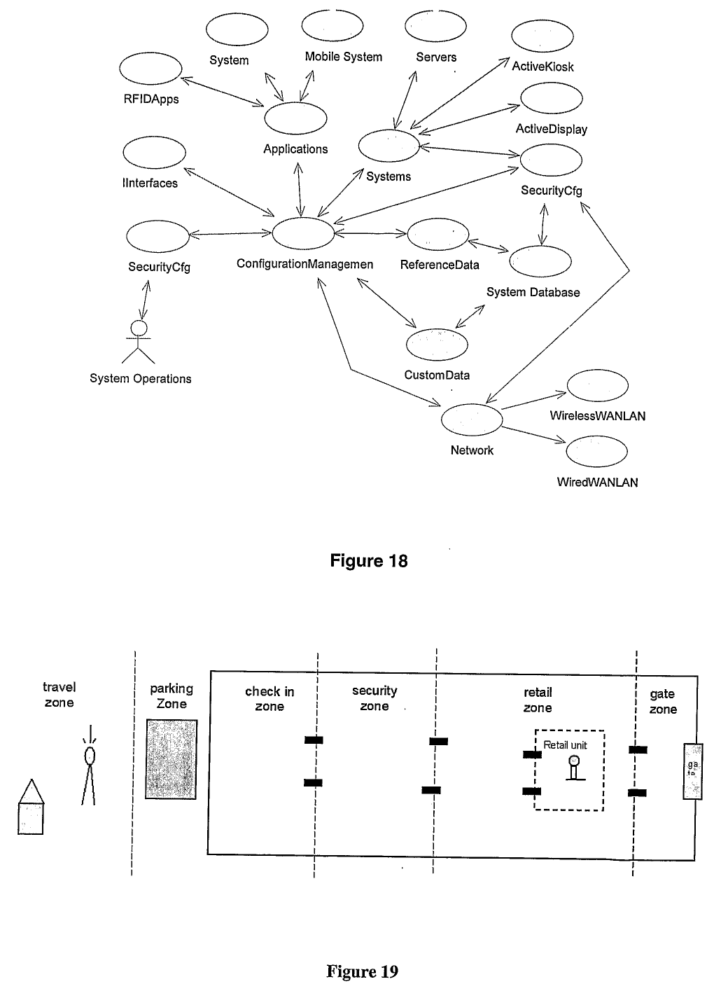

The range of systems, device, user interactions are shown in FIGS. 9 to 14 and 17, 18. Although these examples are tailored to the case of passenger transportation, the skilled person will appreciate that the principles can be extended to any other application of the invention.

There may be different types of kiosks associated with the system and allowing interaction with the system. For example, in the case where a reward is given in cash, the kiosk may be a cash dispenser type, e.g. an ATM linked to the system or with an instance of the system on board. Alternatively, the kiosk may be a voucher type, i.e. having printing facilities and dispensing capabilities. Such kiosks are particularly favoured if placed in the departure gate area as people will get to hear that a person has won a prize and also gets the cash there and then to take on the plane. Other people will then have the length of the flight to hear about this and get interested in how to win next time around, potentially increasing user uptake of the system.

A kiosk may also be implemented as part of a retailer's Electronic Point of Sale (EpoS), for example providing the ability to deliver “cash back” or a discount if the entity is a winner.

A collection kiosk may be used to collect boarding cards, vouchers, ID cards, travel cards or other forms of device which identifies that the entities travelling have actually completed their trip. For instance, if a passenger has collected an RFID activated card (e.g. a boarding card as described in GB2408617) they will have to place the card into the collection kiosk to have any chance of realising their Reward Potential (i.e. if the entity fails to return the card, a NULL Reward Function is applied to the Compliance Factor and/or Reward Potential of that passenger which results in them not winning anything even if they had completely complied up until that point).

Kiosks can also be provided as unmanned EPOS systems (e.g. accepting payment through credit card, using an RFID activated boarding card or other electronic payment methods) which can thus act as voucher redemption and payment integrated kiosk.

Where an entity carries a device which enables them to be tracked within the airport (e.g. an RFID enabled boarding pass, or a barcode enabled boarding pass), it will be appreciated that the kiosk can be implemented in such a way that it can interact with this tracking technology.

In this way, the kiosk can be configured to provide a personalised experience for the entity interacting with it. For example, as the kiosk may be connected to the system, the kiosk can understand the destination of any entity using the kiosk and thus be able to provide specific information about their flight and services available at their destination (e.g. enable them to pre-book taxis, hire-cars, theatre tickets, hotels, etc). This allows for an improvement over typical kiosks currently used in e.g. airports, which are generic and non-specific to the entity interacting with them, thus creating an unsatisfying user experience.

The physical location of the entity interacting with a kiosk may provides the system with a location point and time which may be used as a location/time part of the Breadcrumbing Track of the passenger.

Any airport choke point (e.g. those described in GB2408617) can act as a valid track/time/location point for the system.

### Intelligent Devices

Intelligent devices may have local instances of the invention's system. Thus, each device may on its own or acting in concert (for instance, to pool together each device's Reward Pool to increase the Total Reward Pool available to Entities) use the system to provide its user(s) with incentive(s) to increase its utilisation, for example as a result of using its own (artificial) intelligence and/or software agents and/or input from its operator. Generally, it is preferably that such devices are network enabled (wireless or fixed) to be able to interface with other devices.

One example of this is a situation where there are a range of assets such as communal washing machines or, say, fruit machines. Each asset that is not used does not produce earnings for their operator. So, take the example of communal washing machines in a university where students have registered with the system.

Such students may use the system to connect with other people whilst waiting for their laundry to complete (using a Connection Engine, and increasing the Reward Pool by use of their mobile phones to indicate their participation) and may also be informed by the system that the next wash has not been allocated and that there is a discount if the student takes the next wash within the next 20 minutes. If the Reward Pool is too small, the washing machine may elect to pool with other willing washing machines or other devices (which also have an instance of the invention and may also benefit of artificial intelligence and/or software agents to develop their strategies as a group or on their own) to increase the Reward Pool and make it attractive to students to use them more. If the student does so, the washing machine has increased it utilisation and has made more cash for its operator. Although a relatively simple implementation of the invention, this example shows that the logic of the invention can be embedded in everyday appliances, and the scope of the embodiments of the invention is very wide.

### Security

Security may include the use of VPNs, PGP, firewalls, DomainKey, PKI infrastructure, etc.

The system builds on the “one-click” principles already known in the prior art. When an entity seeks to interact with any instance or part of the system, the entity effectively checks-in and checks-out buying or selling from the invention's system. Beyond the person's details such as address and credit card details, the Digital ID number of their mobile device (DDID) and, potentially, additional identity recognition devices or methods (biometric, biophysical, in person, etc. (AIA)) are used. This may also be combined with time/location information to determine if the person is in the correct relationship with the device.

The client device may be linked with, or have integrated some type of biometric or biophysical device or provide authentication by visual confirmation.

The unique link between the phone or other mobile device and the user is then established and a token stored in an instance of the system and its associated database(s) to note this as a trusted device for which transactions can be trusted. In a sense, the device digital ID is the trusted identifier for that entity.

At any time, such digital ID as trusted identifier for that Entity can be withdrawn if there is some doubt or declaration from any entity that the device association with an entity has been broken. This can be done through a communication with the system removing the trusted status of the token on the system.

One to many, many to one, many to many and inheritance associations and properties are possible in embodiments of the system of the invention, as described below.

A group of entities can be associated in the system with one client device (e.g. a group of people in an office can be billed or interact with the system by using the same mobile phone for instance).

A group of client devices can be used by one Entity (e.g. a person has many mobile phones but wants to be recognised as the same person by the system).

A group of client devices can be used by a group of entities (e.g. a group of people in an office want to be able to use a number of office mobile phones but to be recognised as one entity such as a company for billing and other identity/profile related purposes as far as the system is concerned).

Any client device and/or entity can inherit any part of a “parent” object (e.g. if a group of mobile phones is associated with a trusted ID representing a business and a new mobile phone is added to the pool of phones, that new phone can be simply made to inherit the trusted status of the group of trusted phones as far as the system is concerned). In another example, a new person joining a business which already has a trusted ID as far as the system is concerned, that person can be made to simply inherit the trusted status of the parent entity, the business.

If the client device is a mobile device such as a mobile phone, the system will have the option of adding further security by using the mobile device's own security, as set out above (PKI, PGP, etc.) and see FIG. 20.

If a client device is to be shared by more than one entity or there is some risk that the link between the entity and client device could be compromised, then simply authenticating that device may not be sufficient, the person link with the device needs to be established.

In certain circumstances, it may be appropriate to have temporary tokens linked with a specific journey.

To ensure that the person has not changed either logic or software agent can monitor whether the entity has behaviour that does not match anticipated behavior. If there is a doubt, the identity may be requested to be re-confirmed at that next interaction with the system.

For example, the security aspects of the system may check against both time and location, and perform a practical check to see if the current time and location information is compatible with information already on the system (e.g. if a traveler has recently accessed the system from a kiosk, then the system will not accept an access request from his mobile device if its location is considered to be too far away from that kiosk for it to be carried by him).

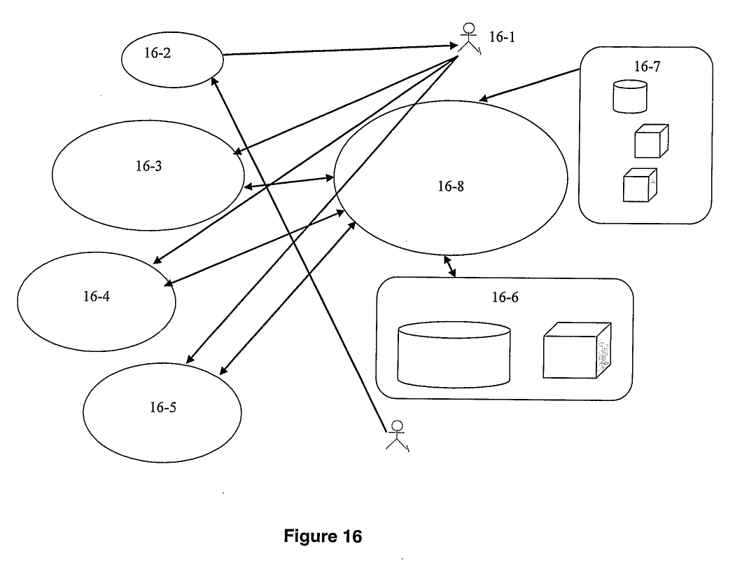

An example of an authentication process is shown in FIG. 16, which, when combined with the earlier description on the process in the description of the Reward Engine, this section and FIG. 20 gives an overview of the process and methods involved.

### Agents:

Animate or Inanimate Object(s) may be shadowed or replaced by Software Agent(s) which together or separately behave like them (either over time as they learn from the Object's interaction with the system or as a default “character” selection which defines a particular Object behaviour e.g. cautious, risk taker, business traveler, holiday maker, etc. which may or may not change thereafter). The Object(s) may have full control over how such Software Agents behave. Such Software Agent(s) may then interact with the system and other objects to, for instance, automatically provide the system with location and/or bets and/or request information on travel information/the Object's Reward Potential at that time/the Object's Compliance Factor and/or offer the Object advice on how to place bets and when, strategies on how to improve their chance of maximising their Reward Potential and actually realising it, winning strategies based on past behaviour or other winning strategies, when and where to shop to increase their Reward Potential, when and where to use the Connection Engine to increase their Reward Potential, etc.

For example, an agent could be created to run on an entity's mobile phone. Such an agent could act as a personalised flight information display, relaying information about current departure time, gate, and flight status. Additionally, based on the entity's location, preferences, and time available before departure the agent could make other recommendations to them (e.g. Visit electronics retailer X for a Y % or V cash discount on personal DVD players . . . and earn an extra 500 reward points, or you are running late pay amount Z to be fast-tracked through the security queue and earn an extra 1000 reward points).

It will be appreciated by one skilled in the art that to deliver a suitable user experience, such an agent would require processing technology to be resident on the mobile phone, for example using Java (J2ME), .NET, or such other development platform as is supported by the mobile phone's operating system. It should also be appreciated that to support the widest user base possible the system would require multiple instances of the agent to be developed, to ensure it can run on the widest number of mobile phone types.

### PARTICULAR EXAMPLES

The following are a number of specific examples of situations where systems embodying the present invention may be implemented.

### Example 1

air passenger transportation—see above sections, GB2408617 and FIG. 19 (different zones with the passenger leaving from home (left of FIG. 19), goes through a car park at the airport, then checks in landside goes through security, etc.

Passenger can bank winnings (s) and leave such items on a system account linked with the invention e.g. PayPal or collect the reward at the end of the trip or at any time later (or bank it for later use with other winnings).

### Example 2

amusement park—see earlier description in the gaming engine section.

Use of the system may be limited by the number of tickets, and the rewards in this example may be food, queue jumping, etc.

### Example 3

device centred engine/intelligent devices—see above description of system for student washing machines.

### Example 4

retailer—operating in a similar manner to the amusement park example above. The retailer may wish to use the Reward Engine and populate the Reward Pool (through the conversion engine) with time and/or location limited vouchers or special offers to make the shopping experience varied and more rewarding.

### Example 5

home events—for example parties, dinners, etc. The system can be used to arrange a particular arrival profile, e.g. to encourage all attendees to arrive within 30 minutes but not all at the same time. The host could use the engines described above to encourage this and reward the relevant person as a result. The system operator may make a charge to the host for configuration of the system in this manner.

### Example 6

people betting on other events/locations—see Gaming Engine(s) section above.

### Example 7

parents or a school offering incentives for children to return home on time and without going via troublesome areas (pubs, etc.—i.e. by applying negative functions to those zones).

Here, the parents can reward or penalise their children for being tracked after a given time (when they are expected to come back home) or all the time. This may also be applied to school trips. In both instances, it is the return from the event either as a group or separately but in a timely manner and safely.

In this example, the system is configured not for travel towards a location/event but also a return journey.

### Example 8

hospital or any other service type delivery—invention used to ensure that patients/customers turn up to appointments with doctors.

It will be appreciated that the systems and methods of the present invention have been described above in relation to specific embodiments, which are not to be taken as limiting the scope of the invention. Modifications and additions, which are not specifically described above, will be apparent to the skilled person and also form part of the present invention.

1. A method of optimizing flow of entities, the method comprising the steps of:
i) tracking a position of a plurality of said entities;
ii) repeatedly:
comparing each position with a target profile; and
calculating or adjusting a reward potential for each entity on the basis of said comparison; and
iii) rewarding a selected number of entities based on a respective reward potential associated with each entity at a predetermined time.

2. A method according to claim 1, wherein a flow of entities is towards a destination, and wherein the step of rewarding is carried out at a required arrival time at said destination.

3. A method according to claim 1, wherein the entities are rewarded, the rewarded entities being selected by virtue of having highest reward potentials at a predetermined time.

4. A method according to claim 1, wherein, for at least one repetition, said step of calculating or adjusting increases the reward potential if the position of the entity falls within the target profile.

5. A method according to claim 1 wherein, for at least one repetition, said step of calculating or adjusting decreases the reward potential if the position of the entity falls within a particular spatial region.

6. A method according to claim 1, wherein said target profile changes with time.

7. A method according to claim 1, wherein the target profile is the same for all of the entities being tracked.

8. A method according to claim 1, further comprising the step of:
adjusting the reward potential for an entity when the entity performs a particular action.

9. A method according to claim 8, wherein the action is a purchase in a retail area, an increase in the reward potential being linked to the monetary amount spent in the retail area.

10. A method according to claim 8, wherein the action is the placing of a bet.

11. A method according to claim 8, wherein the adjustment made to the reward potential depends on the time at which the action is performed.

12. A method according to claim 8, further comprising the step of:
providing a meeting arrangement service to the entities, whereby participation in said meeting arrangement service increases the reward potential of the participating entities.

13. A method according to claim 12 wherein the step of providing a meeting arrangement service uses the position and/or target profile of participating entities to arrange a meeting between a plurality of entities.

14. A method according to claim 12 wherein stored personal information relating to the participating entities is used to match entities for a meeting.

15. A method according to claim 12, wherein the identity of a participating entity is confirmed by using information provided by the entity.

16. A method according to claim 15 wherein the entity arranges to participate in the meeting arrangement service by using a mobile device, and the information provided by the entity is automatically obtained from that mobile device without further input from the entity.

17. A method according to claim 1, wherein the entities are comprised of a plurality of people.

18. A method according to claim 17 wherein at least some of the people are passengers travelling to a departure area.

19. A method according to claim 17, wherein the entities are comprised of a plurality of inanimate objects.

20. A method according to claim 19 wherein at least one of said inanimate objects is associated with a person.

21. A method according to claim 1, further comprising:
storing and analyzing information relating to said tracked positions.

22. A method according to claim 1, wherein the step of rewarding allocates rewards to the selected entities as a share of an accumulated reward pool.

23. A method according to claim 22 wherein the reward pool accumulates value through the actions of the entities which are being tracked.

24. A method according to claim 23 wherein the entities register for tracking by sending a message from a mobile device, and wherein a charge for said message is allocated to the reward pool.

25. A method according to claim 23, wherein a service charge for each bet is allocated to the reward pool.

26. A method according to claim 23, wherein a service charge for participation in the meeting arrangement service is allocated to the reward pool.

27. A method according to claim 1, further comprising the step of:
providing, on request from an entity, an indication of the current likelihood of that entity being selected to be rewarded.

28. A method according to claim 27, wherein the request from the entity is charged for, and that charge is allocated to the reward pool.

29. A system for optimizing flow of entities, the system comprising:
i) a tracking means for tracking the position of a plurality of said entities;
ii) storage means for storing at least one target profile;
iii) a reward engine means to repeatedly:
compare each of said positions against one of said stored target profiles and
calculate or adjust a reward potential for each entity on the basis of said comparison, the reward engine means being further adapted to select a predetermined number of said entities on the basis of the reward function associated with each of said entities at a predetermined time, and to allocate a reward to said selected entities; and
iv) a reward means for distributing said rewards to the selected entities.

30. A system according to claim 29 wherein the flow of entities is towards a destination, and the reward unit is located at that destination.

31. A system according to claim 29 wherein the reward engine is adapted to select those entities with the highest reward potentials on arrival at the predetermined time.

32. A method according to claim 29, wherein the reward engine is also adapted to adjust the reward potential for an entity when the entity performs a particular action.

33. A system according to claim 32 wherein the system further comprises a retailer means, an action being a purchase in a retail area, an increase in the reward potential being linked to the amount spent in the retail area.

34. A system according to claim 32 wherein the system further comprises:
a betting engine means processing bets laying or backing a particular outcome and the action is the placing of a bet.

35. A system according to claim 34 wherein the betting engine processes bets regarding the movement of entities being tracked by the system.

36. A system according to claim 29, further comprising:
a connection engine means arranging meetings between entities on request, and communicates details of the meetings to the participating entities, and further wherein the reward engine is adapted to increase the reward potential of the participating entities.

37. A system according to claim 36 wherein the connection engine is adapted to use the tracked position and/or target profile of the participating entities to arrange a meeting between said entities.

38. A system according to claim 36, further comprising:
storage means for storing personal information relating to the participating entities, wherein said connection engine uses said stored personal information to match entities to arrange a meeting.

39. A system according to claim 36, wherein the connection engine is adapted to confirm the identity of a participating entity by using information provided by the entity prior to the arrangement of a meeting.

40. A system according to claim 39 further comprising:
a receiving unit adapted to receive a message from a mobile device carried by an entity indicating the entity's desire to use the connection engine, said receiving unit and/or said connection engine being adapted to confirm the identity of the entity using data from the mobile device.

41. A system according to claim 29, wherein the entities are comprised of a plurality of people, the tracking unit tracks mobile electronic devices being carried by said people.

42. A system according to claim 41 wherein the tracking unit tracks the mobile electronic devices using a GPS-based system.

43. A system according to claim 41 wherein the mobile electronic devices are mobile telephones and the tracking unit tracks those telephones using a location based service track.

44. A system according to claim 29, further comprising:
storage means for storing and reproducing on demand information relating to said tracked positions.

45. A system according to claim 29, wherein the reward engine is further adapted to receive a request from an entity, and to provide, in response to said request an indication of the current likelihood of that entity being selected to be rewarded.

46. A system according to claim 29, wherein the entity interacts with the system using SMS, voice, instant chat or MMS services.

47. A system according to claim 29, further comprising:
at least one kiosk which provides entities with access to the system and allows entities to interact with the reward engine, betting engine and/or connection engine as desired.

48. A system according to claim 29, further comprising:
a web server allowing entities to access the system and to interact with the reward engine, betting engine and/or connection engine as desired.

49. A system according to claim 29, further comprising:
a billing engine adapted to charge entities for specific interactions with the system, wherein the reward allocated by the reward engine is derived from a pool of the charges made by said billing engine.

50. A system according to claim 29, further comprising:
at least one intelligent device connected to the system, the intelligent device providing information to the reward engine and/or tracking unit, and being capable of adjusting target profiles, reward functions and/or reward potentials for entities.

51. A system according to claim 50 further comprising:
a plurality of intelligent devices being interconnected and sharing information.

52. A system according to claim 29, further comprising:
an intelligent agent associated with at least one entity, said agent interacting with the system on behalf of that entity.
